(19) United States
(12) Patent Application Publication
(10) Pub. No.: US 2024/0333366 A1
(43) Pub. Date: Oct. 3, 2024

(54) JOINT BEAM MANAGEMENT AND CHANNEL STATE INFORMATION REPORTING FOR SIDELINK COMMUNICATIONS

(71) Applicant: QUALCOMM Incorporated, San Diego, CA (US)

(72) Inventors: Jae Ho RYU, San Diego, CA (US); Kazuki TAKEDA, Tokyo (JP)

(21) Appl. No.: 18/593,303

(22) Filed: Mar. 1, 2024

Related U.S. Application Data
(60) Provisional application No. 63/493,925, filed on Apr. 3, 2023.

(51) Int. Cl. H04B 7/06; H04B 7/08; H04L 5/00

(52) U.S. Cl. CPC H04B 7/06952; H04B 7/0632; H04B 7/088; H04L 5/0051

(57) ABSTRACT

Methods, systems, and devices for wireless communications are described. A first device, such as a user equipment (UE) operating in Frequency Range 2 (FR2), may transmit or receive an indication of a joint beam management and channel state information (CSI) reporting scheme that identifies one or more measurement parameters and reporting parameters. The first device may receive reference signals via multi-port CSI reference signal (CSI-RS) resources in accordance with the measurement parameters of the joint beam management and CSI reporting scheme. The first device may transmit, in accordance with the reporting parameters of the joint beam management and CSI reporting scheme, a message that indicates a first set of reporting metrics associated with a first multi-port CSI-RS resource of the multi-port CSI-RS resources. The first device may perform sidelink communications with a second device based on the first set of reporting metrics.

### CROSS REFERENCE

The present Application for Patent claims the benefit of U.S. Provisional Patent Application No. 63/493,925 by RYU et al., entitled “JOINT BEAM MANAGEMENT AND CHANNEL STATE INFORMATION REPORTING FOR SIDELINK COMMUNICATIONS,” filed Apr. 3, 2023, assigned to the assignee hereof, and expressly incorporated by reference herein.

### FIELD OF TECHNOLOGY

The following relates to wireless communications, including joint beam management and channel state information (CSI) reporting for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The techniques described herein relate to improved methods, systems, devices, and apparatuses that support joint beam management and channel state information (CSI) reporting for sidelink communications. In accordance with the techniques described herein, a first device, such as a sidelink user equipment (UE) operating in Frequency Range 2 (FR2), may transmit or receive an indication of a joint beam management and CSI reporting scheme that identifies one or more measurement parameters and reporting parameters. The first device may receive one or more reference signals via multi-port CSI reference signal (CSI-RS) resources in accordance with the measurement parameters of the joint beam management and CSI reporting scheme. The first device may transmit, in accordance with the reporting parameters of the joint beam management and CSI reporting scheme, a message that indicates a first set of reporting metrics associated with a first multi-port CSI-RS resource of the multi-port CSI-RS resources.

A method for wireless communication at a first device is described. The method may include: transmitting or receiving an indication of a joint beam management and CSI reporting scheme that identifies one or more measurement parameters and one or more reporting parameters; receiving multiple reference signals via a set of multi-port CSI-RS resources in accordance with the one or more measurement parameters of the joint beam management and CSI reporting scheme; and transmitting, in accordance with the one or more reporting parameters of the joint beam management and CSI reporting scheme, a message that indicates a first set of reporting metrics associated with a first multi-port CSI-RS resource of the set of multi-port CSI-RS resources.

An apparatus for wireless communication at a first device is described. The apparatus may include a processor, memory coupled with the processor, and instructions stored in the memory. The instructions may be executable by the processor to cause the apparatus to: transmit or receive an indication of a joint beam management and CSI reporting scheme that identifies one or more measurement parameters and one or more reporting parameters; receive multiple reference signals via a set of multi-port CSI-RS resources in accordance with the one or more measurement parameters of the joint beam management and CSI reporting scheme; and transmit, in accordance with the one or more reporting parameters of the joint beam management and CSI reporting scheme, a message that indicates a first set of reporting metrics associated with a first multi-port CSI-RS resource of the set of multi-port CSI-RS resources.

Another apparatus for wireless communication at a first device is described. The apparatus may include: means for transmitting or receiving an indication of a joint beam management and CSI reporting scheme that identifies one or more measurement parameters and one or more reporting parameters; means for receiving multiple reference signals via a set of multi-port CSI-RS resources in accordance with the one or more measurement parameters of the joint beam management and CSI reporting scheme; and means for transmitting, in accordance with the one or more reporting parameters of the joint beam management and CSI reporting scheme, a message that indicates a first set of reporting metrics associated with a first multi-port CSI-RS resource of the set of multi-port CSI-RS resources.

A non-transitory computer-readable medium storing code for wireless communication at a first device is described. The code may include instructions executable by a processor to: transmit or receive an indication of a joint beam management and CSI reporting scheme that identifies one or more measurement parameters and one or more reporting parameters; receive multiple reference signals via a set of multi-port CSI-RS resources in accordance with the one or more measurement parameters of the joint beam management and CSI reporting scheme; and transmit, in accordance with the one or more reporting parameters of the joint beam management and CSI reporting scheme, a message that indicates a first set of reporting metrics associated with a first multi-port CSI-RS resource of the set of multi-port CSI-RS resources.

In some examples of the methods, apparatuses, and non-transitory computer-readable media described herein, the first set of reporting metrics include a rank indicator (RI) and a channel quality indicator (CQI) associated with the first multi-port CSI-RS resource.

In some examples of the methods, apparatuses, and non-transitory computer-readable media described herein, the message further indicates a second set of reporting metrics associated with a second multi-port CSI-RS resource of the multiple multi-port CSI-RS resources.

In some examples of the methods, apparatuses, and non-transitory computer-readable media described herein, the one or more reporting parameters indicate a quantity of multi-port CSI-RS resources for which the first device is to provide reporting metrics.

In some examples of the methods, apparatuses, and non-transitory computer-readable media described herein, the first device includes a sidelink UE operating in FR2.

Some examples of the methods, apparatuses, and non-transitory computer-readable media described herein may further include operations, features, means, or instructions for receiving an indication of a CSI-RS resource identifier (CRI) associated with a transmit beam of a second device from which the multiple reference signals are received, where the transmit beam of the second device corresponds to the first multi-port CSI-RS resource.

In some examples of the methods, apparatuses, and non-transitory computer-readable media described herein, the multiple reference signals may be received using a fixed multi-port receive beam of the first device.

Some examples of the methods, apparatuses, and non-transitory computer-readable media described herein may further include operations, features, means, or instructions for selecting a transmit or receive beam to use for communications with a second device based on measuring the multiple reference signals in accordance with the one or more measurement parameters of the joint beam management and CSI reporting scheme.

In some examples of the methods, apparatuses, and non-transitory computer-readable media described herein, the first multi-port CSI-RS resource corresponds to the transmit or receive beam selected by the first device.

In some examples of the methods, apparatuses, and non-transitory computer-readable media described herein, the message includes a sidelink CSI reporting medium access control-control element (MAC-CE) indicating the first set of reporting metrics associated with the first multi-port CSI-RS resource.

In some examples of the methods, apparatuses, and non-transitory computer-readable media described herein, a format of the sidelink CSI reporting MAC-CE may be based on a quantity of multi-port CSI-RS resources for which the first device is to provide reporting metrics.

In some examples of the methods, apparatuses, and non-transitory computer-readable media described herein, the message includes a quantity of bits that indicate a CRI associated with the first multi-port CSI-RS resource.

Some examples of the methods, apparatuses, and non-transitory computer-readable media described herein may further include operations, features, means, or instructions for: receiving hybrid automatic repeat request acknowledgement (HARQ-ACK) feedback for the message indicating the first set of reporting metrics associated with the first multi-port CSI-RS resource; and updating a receive beam of the first device after a threshold quantity of milliseconds has elapsed with respect to reception of the HARQ-ACK feedback.

In some examples of the methods, apparatuses, and non-transitory computer-readable media described herein, the joint beam management and CSI reporting scheme indicates the threshold quantity of milliseconds.

In some examples of the methods, apparatuses, and non-transitory computer-readable media described herein, the receive beam of the first device corresponds to the first multi-port CSI-RS resource.

Some examples of the methods, apparatuses, and non-transitory computer-readable media described herein may further include operations, features, means, or instructions for: receiving a second message including a transmission configuration indicator (TCI) associated with a transmit beam of a second device from which the multiple reference signals are received; and transmitting HARQ-ACK feedback for the second message in accordance with the joint beam management and CSI reporting scheme.

In some examples of the methods, apparatuses, and non-transitory computer-readable media described herein, the message further indicates a second set of reporting metrics associated with a second multi-port CSI-RS resource of the multiple multi-port CSI-RS resources, and the TCI associated with the transmit beam of the second device corresponds to the first multi-port CSI-RS resource or the second multi-port CSI-RS resource.

Some examples of the methods, apparatuses, and non-transitory computer-readable media described herein may further include operations, features, means, or instructions for updating a receive beam of the first device based on the TCI associated with the transmit beam of the second device, where the receive beam is updated after a threshold quantity of milliseconds has elapsed with respect to transmission of the HARQ-ACK feedback.

In some examples of the methods, apparatuses, and non-transitory computer-readable media described herein, the multiple reference signals may be received in accordance with a multi-port receive beam sweeping scheme.

Some examples of the methods, apparatuses, and non-transitory computer-readable media described herein may further include operations, features, means, or instructions for transmitting a request for a second device to transmit reference signals in accordance with a beam repetition pattern, where the multiple reference signals are received in accordance with the request.

Some examples of the methods, apparatuses, and non-transitory computer-readable media described herein may further include operations, features, means, or instructions for: performing a multi-port receive beam sweeping procedure based on receiving the multiple reference signals in accordance with the one or more measurement parameters of the joint beam management and CSI reporting scheme; and updating a receive beam of the first device based on a result of the multi-port receive beam sweeping procedure.

In some examples of the methods, apparatuses, and non-transitory computer-readable media described herein, the first multi-port CSI-RS resource corresponds to the receive beam updated by the first device.

A method for wireless communication at a second device is described. The method may include: transmitting or receiving an indication of a joint beam management and CSI reporting scheme that identifies one or more measurement parameters and one or more reporting parameters; transmitting multiple reference signals via a set of multi-port CSI-RS resources in accordance with the one or more measurement parameters of the joint beam management and CSI reporting scheme; and receiving, in accordance with the one or more reporting parameters of the joint beam management and CSI reporting scheme, a message that indicates a first set of reporting metrics associated with a first multi-port CSI-RS resource of the set of multi-port CSI-RS resources.

An apparatus for wireless communication at a second device is described. The apparatus may include a processor, memory coupled with the processor, and instructions stored in the memory. The instructions may be executable by the processor to cause the apparatus to: transmit or receive an indication of a joint beam management and CSI reporting scheme that identifies one or more measurement parameters and one or more reporting parameters; transmit multiple reference signals via a set of multi-port CSI-RS resources in accordance with the one or more measurement parameters of the joint beam management and CSI reporting scheme; and receive, in accordance with the one or more reporting parameters of the joint beam management and CSI reporting scheme, a message that indicates a first set of reporting metrics associated with a first multi-port CSI-RS resource of the set of multi-port CSI-RS resources.

Another apparatus for wireless communication at a second device is described. The apparatus may include: means for transmitting or receiving an indication of a joint beam management and CSI reporting scheme that identifies one or more measurement parameters and one or more reporting parameters; means for transmitting multiple reference signals via a set of multi-port CSI-RS resources in accordance with the one or more measurement parameters of the joint beam management and CSI reporting scheme; and means for receiving, in accordance with the one or more reporting parameters of the joint beam management and CSI reporting scheme, a message that indicates a first set of reporting metrics associated with a first multi-port CSI-RS resource of the set of multi-port CSI-RS resources.

A non-transitory computer-readable medium storing code for wireless communication at a second device is described. The code may include instructions executable by a processor to: transmit or receive an indication of a joint beam management and CSI reporting scheme that identifies one or more measurement parameters and one or more reporting parameters; transmit multiple reference signals via a set of multi-port CSI-RS resources in accordance with the one or more measurement parameters of the joint beam management and CSI reporting scheme; and receive, in accordance with the one or more reporting parameters of the joint beam management and CSI reporting scheme, a message that indicates a first set of reporting metrics associated with a first multi-port CSI-RS resource of the set of multi-port CSI-RS resources.

In some examples of the methods, apparatuses, and non-transitory computer-readable media described herein, the multiple reference signals may be transmitted using multiple transmit beams of the second device in accordance with a multi-port beam sweeping pattern.

In some examples of the methods, apparatuses, and non-transitory computer-readable media described herein, the multiple reference signals may be transmitted using a first transmit beam of the second device in accordance with a multi-port fixed beam repetition pattern.

In some examples of the methods, apparatuses, and non-transitory computer-readable media described herein, the first set of reporting metrics include a RI and a CQI associated with the first multi-port CSI-RS resource.

In some examples of the methods, apparatuses, and non-transitory computer-readable media described herein, the message further indicates a second set of reporting metrics associated with a second multi-port CSI-RS resource of the multiple multi-port CSI-RS resources.

In some examples of the methods, apparatuses, and non-transitory computer-readable media described herein, the second device includes a sidelink UE operating in FR2.

Some examples of the methods, apparatuses, and non-transitory computer-readable media described herein may further include operations, features, means, or instructions for transmitting an indication of a CRI associated with a transmit beam of the second device, where the transmit beam of the second device corresponds to the first multi-port CSI-RS resource.

Some examples of the methods, apparatuses, and non-transitory computer-readable media described herein may further include operations, features, means, or instructions for selecting a transmit or receive beam to use for communications with a first device based on the first set of reporting metrics associated with the first multi-port CSI-RS resource.

In some examples of the methods, apparatuses, and non-transitory computer-readable media described herein, the message includes a sidelink CSI reporting MAC-CE indicating the first set of reporting metrics associated with the first multi-port CSI-RS resource.

In some examples of the methods, apparatuses, and non-transitory computer-readable media described herein, the message further indicates a CRI associated with the first multi-port CSI-RS resource.

Some examples of the methods, apparatuses, and non-transitory computer-readable media described herein may further include operations, features, means, or instructions for: transmitting HARQ-ACK feedback for the message indicating the first set of reporting metrics associated with the first multi-port CSI-RS resource; and updating a transmit beam of the second device after a threshold quantity of milliseconds has elapsed with respect to transmission of the HARQ-ACK feedback.

In some examples of the methods, apparatuses, and non-transitory computer-readable media described herein, the joint beam management and CSI reporting scheme indicates the threshold quantity of milliseconds.

In some examples of the methods, apparatuses, and non-transitory computer-readable media described herein, the transmit beam of the second device corresponds to the first multi-port CSI-RS resource.

Some examples of the methods, apparatuses, and non-transitory computer-readable media described herein may further include operations, features, means, or instructions for: transmitting a second message including a TCI associated with a transmit beam of the second device; and receiving HARQ-ACK feedback for the second message in accordance with the joint beam management and CSI reporting scheme.

Some examples of the methods, apparatuses, and non-transitory computer-readable media described herein may further include operations, features, means, or instructions for updating a transmit beam of the second device after a threshold quantity of milliseconds has elapsed with respect to reception of the HARQ-ACK feedback.

In some examples of the methods, apparatuses, and non-transitory computer-readable media described herein, the message further indicates a second set of reporting metrics associated with a second multi-port CSI-RS resource of the multiple multi-port CSI-RS resources and the TCI from the second message corresponds to the first multi-port CSI-RS resource or the second multi-port CSI-RS resource.

Some examples of the methods, apparatuses, and non-transitory computer-readable media described herein may further include operations, features, means, or instructions for receiving a request for the second device to transmit reference signals in accordance with a beam repetition pattern, where the multiple reference signals are transmitted in accordance with the request.

### BRIEF DESCRIPTION OF THE DRAWINGS

FIGS. 1 and 2 show examples of wireless communications systems that support joint beam management and channel state information (CSI) reporting for sidelink communications in accordance with one or more aspects of the present disclosure.

FIGS. 3A and 3B show examples of resource diagrams that support joint beam management and CSI reporting for sidelink communications in accordance with one or more aspects of the present disclosure.

FIG. 4 shows an example of a beam management procedure that supports joint beam management and CSI reporting for sidelink communications in accordance with one or more aspects of the present disclosure.

FIG. 5 shows an example of a resource diagram that supports joint beam management and CSI reporting for sidelink communications in accordance with one or more aspects of the present disclosure.

FIGS. 6A and 6B show examples of process flows that support joint beam management and CSI reporting for sidelink communications in accordance with one or more aspects of the present disclosure.

FIGS. 7A and 7B show examples of process flows that supports joint beam management and CSI reporting for sidelink communications in accordance with one or more aspects of the present disclosure.

FIGS. 8 and 9 show block diagrams of devices that support joint beam management and CSI reporting for sidelink communications in accordance with one or more aspects of the present disclosure.

FIG. 10 shows a block diagram of a communications manager that supports joint beam management and CSI reporting for sidelink communications in accordance with one or more aspects of the present disclosure.

FIG. 11 shows a diagram of a system including a device that supports joint beam management and CSI reporting for sidelink communications in accordance with one or more aspects of the present disclosure.

FIGS. 12 and 13 show flowcharts illustrating methods that support joint beam management and CSI reporting for sidelink communications in accordance with one or more aspects of the present disclosure.

### DETAILED DESCRIPTION

In some wireless communications systems, devices may use channel state information (CSI) reporting techniques to improve or maintain the reliability of sidelink communications. For example, a first user equipment (UE) may transmit a CSI reference signal (CSI-RS) to a second UE such that the second UE can measure and report various metrics associated with the CSI-RS. For example, the second UE may report a rank indicator (RI) or a channel quality indicator (CQI) associated with the CSI-RS. The first UE may use the CSI provided by the second UE to select or update various parameters (such as a resource allocation, modulation scheme, or transmit power) for the sidelink communications. Additionally, or alternatively, some devices may use beam management techniques (e.g., beam sweeping and beam refinement) to improve the coverage or quality of beamformed communications. For instance, the first UE may use a Layer 1 reference signal received power (L1-RSRP) value or a signal to interference and noise ratio (SINR) provided by the second UE to select or update a transmit beam configuration of the first UE. However, some CSI reporting schemes and beam management procedures may be unsuitable for environments with high channel variability and device mobility.

Aspects of the present disclosure support joint beam management and CSI reporting techniques that enable devices to dynamically monitor communication beams and channel conditions with reduced latency and lower signaling overhead. In accordance with the techniques described herein, a first device may be configured with a joint beam management and CSI reporting scheme that indicates one or more measurement parameters and reporting parameters. Accordingly, the first device may receive one or more reference signals via multi-port CSI-RS resources in accordance with the measurement parameters of the joint beam management and CSI reporting scheme. Thereafter, the first device may transmit a message indicating various reporting metrics associated with a first multi-port CSI-RS resource. The reporting metrics provided by the first device may be used for beam maintenance (for example, selecting a suitable transmit beam) and channel monitoring (for example, determining the reliability of a wireless channel).

Configuring the first device to receive reference signals via multi-port CSI-RS resources and provide reporting metrics in accordance with a joint beam management and CSI reporting scheme may reduce the latency associated with beam management and CSI reporting operations, for example, by reducing the number of reference signals received/measured by the first device. Furthermore, as the reporting metrics provided by the first device can be used for multiple purposes (e.g., beam maintenance and channel adaptation), the first device may transmit fewer (e.g., half as many) messages, which may reduce the signaling overhead associated with joint beam management and CSI reporting procedures.

Aspects of the present disclosure are initially described in the context of wireless communications systems, resource diagrams, beam management procedures, and process flows. Aspects of the present disclosure are further illustrated by and described with reference to apparatus diagrams, system diagrams, and flowcharts that relate to joint beam management and CSI reporting for sidelink communications.

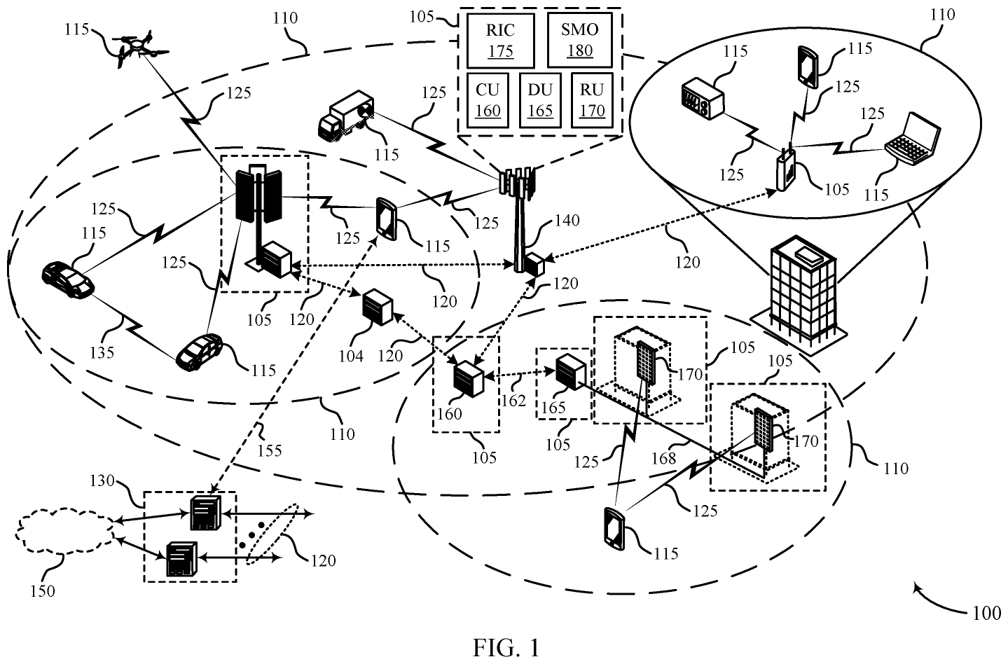

FIG. 1 shows an example of a wireless communications system 100 that supports joint beam management and CSI reporting for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support joint beam management and CSI reporting for sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with aspects of the present disclosure, a first UE 115 (e.g., a sidelink device operating in FR2) may transmit or receive an indication of a joint beam management and CSI reporting scheme that identifies one or more measurement parameters and reporting parameters. In some examples, the first UE 115 may receive the indication of the joint beam management and CSI reporting scheme from a network entity 105. Accordingly, the first UE 115 may receive one or more reference signals from a second UE 115 via multi-port CSI-RS resources in accordance with the measurement parameters of the joint beam management and CSI reporting scheme. The first UE 115 may transmit, in accordance with the reporting parameters of the joint beam management and CSI reporting scheme, a message indicating one or more reporting metrics associated with a first multi-port CSI-RS resource of the multi-port CSI-RS resources.

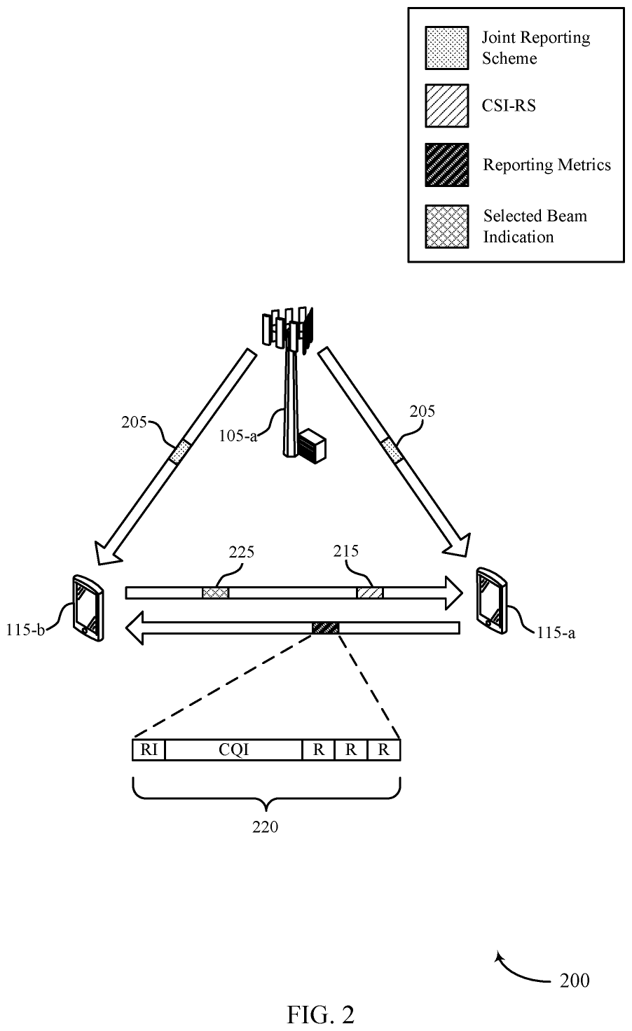

FIG. 2 shows an example of a wireless communications system 200 that supports joint beam management and CSI reporting for sidelink communications in accordance with one or more aspects of the present disclosure. The wireless communications system 200 may implement or be implemented by aspects of the wireless communications system 100. For example, the wireless communications system 200 includes a UE 115-a (e.g., a first device), a UE 115-b (e.g., a second device), and a network entity 105-a, which may be examples of corresponding devices described herein, including with reference to FIG. 1. In some examples, the UE 115-a may communicate with the UE 115-b via one or more sidelink channels in FR2.

As described herein, some devices (such as the UE 115-a and the UE 115-b) may use CSI reporting techniques to improve or maintain the reliability of sidelink communications. For example, the UE 115-b may transmit CSI-RSs 215 to the UE 115-a, such that the UE 115-a can measure and report various metrics associated with the CSI-RSs 215. For example, the UE 115-a may report an RI or a CQI associated with the CSI-RSs 215. The UE 115-b may use the CSI provided by the UE 115-a to select or update various communication parameters, such as a resource allocation, modulation scheme, or a transmit power for sidelink communications between the UE 115-a and the UE 115-b.

Additionally, or alternatively, some devices may use beam management techniques (e.g., beam sweeping and beam refinement) to improve the coverage or quality of beamformed communications. For instance, the UE 115-b may use an L1-RSRP or a SINR reported by the UE 115-a to select or update a transmit beam configuration of the UE 115-b. However, some CSI reporting schemes and beam management procedures may be unsuitable for sidelink communications in FR2, as these communications may involve rapid beam changes and high device mobility.

The wireless communications system 200 may support joint beam management and CSI reporting techniques that enable devices to dynamically monitor communication beams and estimate channel conditions with reduced latency and lower signaling overhead. In accordance with aspects of the present disclosure, the UE 115-a and the UE 115-b may be configured with a joint beam management and CSI reporting scheme 205 that indicates one or more measurement parameters and reporting parameters. In some examples, the UE 115-a may receive an indication of the joint beam management and CSI reporting scheme 205 from the network entity 105-a (e.g., via RRC signaling) or the UE 115-b (e.g., via a sidelink control message). In other examples, the UE 115-a may transmit an indication of the joint beam management and CSI reporting scheme 205 to the UE 115-b (or vice versa). In other examples, the joint beam management and CSI reporting scheme 205 may be preconfigured or retrieved from memory.

Accordingly, the UE 115-a may receive CSI-RSs 215 via multi-port CSI-RS resources in accordance with the measurement parameters of the joint beam management and CSI reporting scheme 205. Thereafter, the UE 115-a may transmit a message (such as a sidelink CSI reporting MAC-CE) indicating various reporting metrics 220 (such as RI/CQI) associated with one or more of the multi-port CSI-RS resources. More specifically, the message may include a 1-bit field indicating the derived value of the RI for sidelink CSI reporting, and a 4-bit field indicating the derived value of the CQI for sidelink CSI reporting. The reporting metrics 220 provided by the UE 115-a may be used for beam maintenance and channel estimation. For example, the UE 115-b may use the reporting metrics 220 provided by the UE 115-a to select a suitable transmit beam, estimate the quality of a sidelink channel between the UE 115-a and the UE 115-b, or both.

After selecting a suitable transmit beam to use for sidelink communications with the UE 115-a, the UE 115-b may transmit an indication 225 of the selected transmit beam to the UE 115-a. The indication 225 may include, for example, a CSI-RS resource identifier (CRI) associated with the transmit beam selected by the UE 115-b. In some examples, there may be additional message exchanges between the UE 115-a and the UE 115-b. For example, the UE 115-b may transmit the CSI-RSs 215 to the UE 115-a in response to a request from the UE 115-a. Additionally, or alternatively, the UE 115-b may transmit HARQ-ACK feedback for the reporting metrics 220, and the UE 115-a may transmit HARQ-ACK feedback for the indication 225 of the selected transmit beam.

Configuring the UE 115-a to receive reference signals via multi-port CSI-RS resources and provide reporting metrics to the UE 115-b in accordance with the joint beam management and CSI reporting scheme 205 may reduce the latency associated with beam management and CSI reporting operations between the UE 115-a and the UE 115-b, for example, by reducing the number of reference signals received/measured by the UE 115-a. Furthermore, as the reporting metrics 220 provided by the UE 115-a can be used for multiple purposes (e.g., beam maintenance and channel estimation), the UE 115-a may transmit fewer (e.g., half as many) sidelink control messages, which may reduce the signaling overhead associated with beam management and CSI reporting operations between the UE 115-a and the UE 115-b.

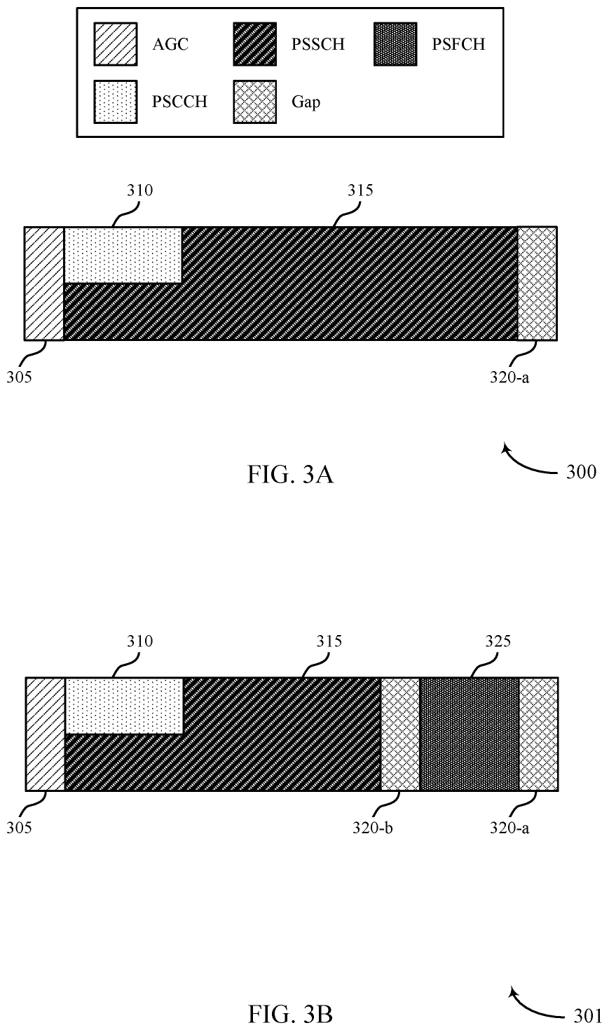

FIGS. 3A and 3B illustrate examples of a resource diagram 300 and a resource diagram 301 that support joint beam management and CSI reporting for sidelink communications in accordance with one or more aspects of the present disclosure. The resource diagram 300 and the resource diagram 301 may implement or be implemented by aspects of the wireless communications system 100 or the wireless communications system 200. For example, the resource diagram 300 and the resource diagram 301 may be implemented by a sidelink device, such as the UE 115-a or the UE 115-b described with reference to FIG. 2. The resource diagram 300 illustrates an example of an NR sidelink slot structure without physical sidelink feedback channel (PSFCH) resources, while the resource diagram 301 illustrates an example of an NR sidelink slot structure that includes PSFCH resources 325.

As described herein, a slot may be sub-divided into 14 OFDM symbols. The first symbol 305 of the slot may be a repetition of the following symbol that is used for automatic gain control (AGC) settling. In some examples, a gap symbol 320-a may be present after physical sidelink shared channel (PSSCH) resources 315. Physical sidelink control channel (PSCCH) resources 310 and PSSCH resources 315 may be included in the same slot. PSFCH resources 325 can be used for feedback transmission in the last two symbols of the slot. In some examples, there may be a gap symbol 320-b between the PSSCH resources 315 and the PSFCH resources 325.

The NR sidelink slot structures illustrated in FIGS. 3A and 3B may support sidelink CSI reporting procedures. As described herein, aperiodic CSI reporting may be supported for unicast sidelink communications. For example, a first UE (such as the UE 115-b described with reference to FIG. 2) may explicitly trigger a CSI report via sidelink control information (SCI), and may include CSI-RS(s) in the corresponding PSSCH transmission. Accordingly, a second UE (such as the UE 115-a described with reference to FIG. 2) may report CSI via a MAC-CE using PSSCH resources within a latency bound (for example 3-160 slots).

The CSI report from the second UE may include a 1-bit RI field and a 4-bit CQI field. The first UE may provide the second UE with a PC5-RRC configuration for CSI-RS and CSI reporting latency before triggering the aperiodic CSI report. In some examples, the configuration may include a sl-LatencyBoundCSI-Report field indicating the latency bound of sidelink CSI reports (given as a number of slots) from the associated sidelink CSI trigger. The first UE may transmit sidelink CSI-RS within a unicast PSSCH transmission if CSI reporting is enabled by the higher layer parameter sl-CSI-Acquisition and the ‘CSI request’ field in the corresponding SCI format 2-A is set to 1.

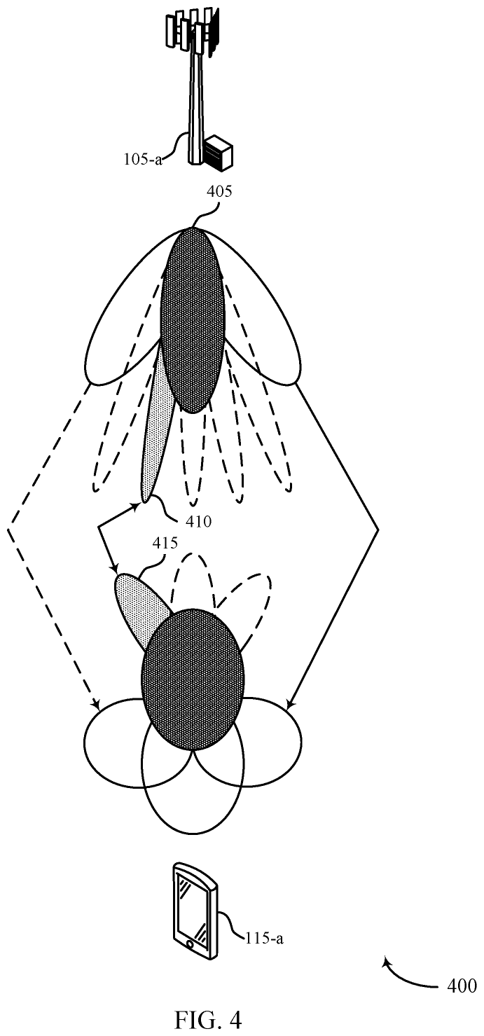

FIG. 4 illustrates an example of a beam management procedure 400 that supports joint beam management and CSI reporting for sidelink communications in accordance with one or more aspects of the present disclosure. The beam management procedure 400 may implement or be implemented by aspects of any of the wireless communications systems and resource diagrams described with reference to FIGS. 1 through 3B. For example, the beam management procedure 400 includes a UE 115-a and a network entity 105-a, which may be examples of corresponding devices described herein, including with reference to FIG. 2. The beam management procedure 400 illustrates a multi-step beam selection/refinement process between the UE 115-a and the network entity 105-a.

As described herein with reference to FIGS. 1 through 3, some wireless communications systems may support sidelink communications in the FR2 licensed spectrum. For example, some wireless communications systems (such as the wireless communications system 200 described with reference to FIG. 2) may support sidelink beam management (including initial beam pairing, beam maintenance, and beam failure recovery) using a sidelink CSI reporting framework and various Uu beam management techniques. Beam management in the FR2 licensed spectrum may be applicable to unicast communications between devices.

In the beam management procedure 400, the network entity 105-a and the UE 115-a may establish a transmit/receive beam pair before initiating communications in FR2. The beam management procedure 400 may include 3 stages. In the first 2 stages (P1 and P2), the UE 115-a may be configured to measure and report RSRP based on one or more of an SSB 405 or a CSI-RS to help the network entity 105-a select or refine downlink transmit beams. The network entity 105-a may indicate the selected beam 410 to the UE 115-a via a transmission configuration indicator (TCI). The first 2 stages of the beam management procedure 400 may be an example of an explicit beam maintenance scheme, as the UE 115-a explicitly provides the network entity 105-a with RSRP measurements. In the third stage (P3), the UE 115-a may refine a receive beam 415 without reporting RSRP to the network entity 105-a. The third stage may be an example of an implicit beam maintenance procedure, as the RSRP is implicitly used to calibrate or otherwise refine the receive beam 415. If the UE 115-a supports beam correspondence, the UE 115-a may also perform transmit beam refinement.

In accordance with aspects of the present disclosure, the UE 115-a (e.g., a sidelink device operating in FR2) may transmit or receive an indication of a joint beam management and CSI reporting scheme that identifies one or more measurement parameters and reporting parameters. In some examples, the UE 115-a may receive the indication of the joint beam management and CSI reporting scheme from the network entity 105-a or another sidelink device. Accordingly, the UE 115-a may receive one or more reference signals via multi-port CSI-RS resources in accordance with the measurement parameters of the joint beam management and CSI reporting scheme. The UE 115-a may transmit, in accordance with the reporting parameters of the joint beam management and CSI reporting scheme, a message indicating one or more reporting metrics associated with a first multi-port CSI-RS resource of the multi-port CSI-RS resources.

Configuring the UE 115-a to receive reference signals via multi-port CSI-RS resources and provide reporting metrics in accordance with a joint beam management and CSI reporting scheme may reduce the latency associated with beam management and CSI reporting operations between the UE 115-a and other sidelink devices, for example, by reducing the number of reference signals received/measured by the UE 115-a. Furthermore, as the reporting metrics provided by the UE 115-a can be used for multiple purposes (e.g., beam maintenance and channel estimation), the UE 115-a may transmit fewer (e.g., half as many) sidelink control messages, which may reduce the signaling overhead associated with beam management and CSI reporting operations between the UE 115-a and other sidelink devices.

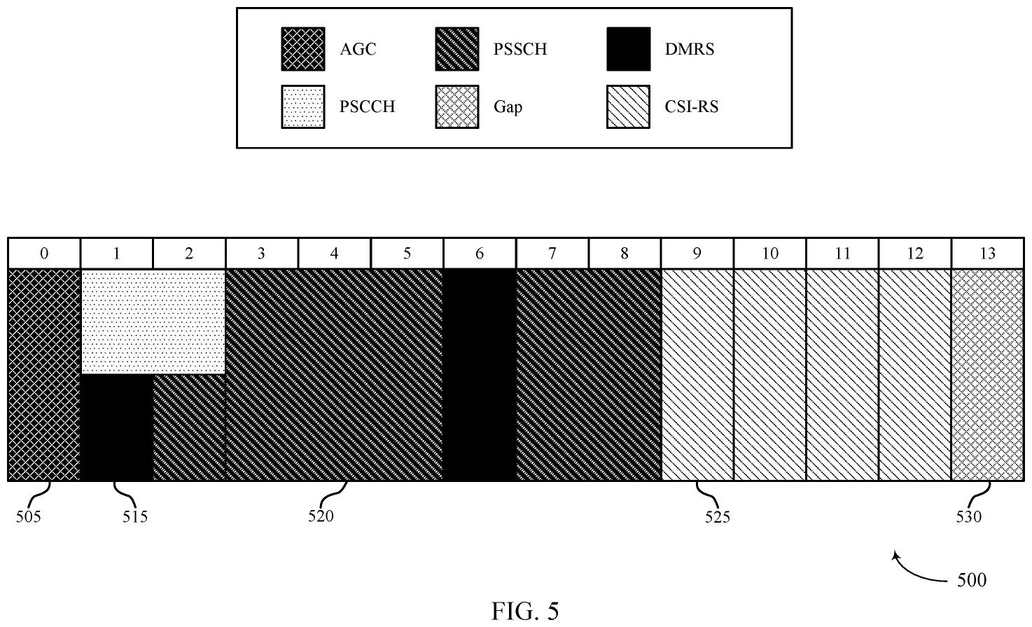

FIG. 5 illustrates an example of a resource diagram 500 that supports joint beam management and CSI reporting for sidelink communications in accordance with one or more aspects of the present disclosure. The resource diagram 500 may implement or be implemented by aspects of any of the wireless communications systems, resource diagrams, or beam management procedures described herein, including with reference to FIGS. 1 through 4. For example, the resource diagram 500 may be implemented by a sidelink device, such as the UE 115-a or the UE 115-b described with reference to FIG. 2. The resource diagram 500 illustrates a slot structure that supports beam management for sidelink devices operating in FR2.

As described herein, a slot may be sub-divided into 14 OFDM symbols. The first symbol 505 of the slot (referred to herein as the AGC symbol) may be a repetition of the following symbol that is used for AGC settling. In some examples, the last symbol of the slot may be a gap symbol 530. The slot may also include CSI-RS resources 525 and PSSCH resources 520, which may be used for CSI-RS transmission and sidelink data transmission, respectively. The slot may also include PSCCH resources and demodulation reference signal (DMRS) resources 515, which may be used for transmission of sidelink control messages and DMRS(s), respectively.

Sidelink operations in FR2 may utilize beamformed transmission and reception to attain higher sidelink coverage. Some wireless communications systems may support beam management for sidelink UEs operating in FR2. Beam management generally refers to initial beam pairing between two sidelink UEs, beam maintenance during unicast sidelink communications, and beam failure detection/recovery.

Beam maintenance includes explicit beam maintenance and implicit beam maintenance. In an explicit beam maintenance procedure, a first UE (such as the UE 115-b described with reference to FIG. 2) may transmit CSI-RS in accordance with a transmit beam sweeping pattern, and a second UE (such as the UE 115-a described with reference to FIG. 2) may measure and report L1-RSRP based on the CSI-RS. Accordingly, the first UE may select a transmit beam based on the L1-RSRP provided by the second UE, and may transmit an indication of the selected beam to the second UE. In an implicit beam maintenance procedure, the first UE may transmit CSI-RS in accordance with a transmit beam repetition pattern, and the second UE may receive the CSI-RS in accordance with a receive beam sweeping pattern. The second UE may use measurements of the CSI-RS to perform beam refinement.

In accordance with aspects of the present disclosure, the second UE (e.g., a sidelink device operating in FR2) may transmit or receive an indication of a joint beam management and CSI reporting scheme that identifies one or more measurement parameters and reporting parameters. In some examples, the second UE may receive the indication of the joint beam management and CSI reporting scheme from a network entity or another sidelink device. Accordingly, the second UE may receive one or more reference signals via multi-port CSI-RS resources in accordance with the measurement parameters of the joint beam management and CSI reporting scheme. The second UE may transmit, in accordance with the reporting parameters of the joint beam management and CSI reporting scheme, a message indicating one or more reporting metrics associated with a first multi-port CSI-RS resource of the multi-port CSI-RS resources.

Configuring the second UE to receive reference signals from the first UE via multi-port CSI-RS resources and provide reporting metrics in accordance with a joint beam management and CSI reporting scheme may reduce the latency associated with beam management and CSI reporting operations between the first UE and the second UE, for example, by reducing the number of reference signals received/measured by the second UE. Furthermore, as the reporting metrics provided by the second UE can be used for multiple purposes (e.g., beam maintenance and channel estimation), the second UE may transmit fewer (e.g., half as many) sidelink control messages, which may reduce the signaling overhead associated with beam management and CSI reporting operations between the first UE and the second UE.

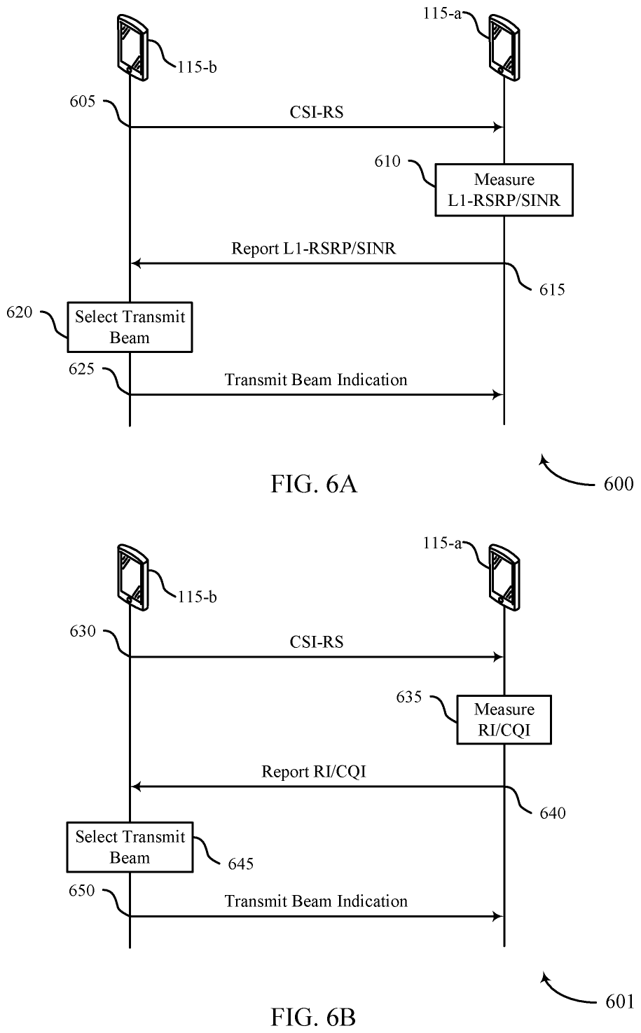

FIGS. 6A and 6B illustrate examples of a process flow 600 and a process flow 601 that support joint beam management and CSI reporting for sidelink communications in accordance with one or more aspects of the present disclosure. The process flow 600 and the process flow 601 may implement or be implemented by aspects of any of the wireless communications systems, resource diagrams, or beam management procedures described with reference to FIGS. 1 through 5. For example, the process flow 600 and the process flow 601 include a UE 115-a (e.g., a first device) and a UE 115-b (e.g., a second device), which may be examples of corresponding devices described herein, including with reference to FIGS. 1 through 5. In the following description of the process flow 600 and the process flow 601, operations between the UE 115-a and the UE 115-b may be added, omitted, or performed in a different order (with respect to the exemplary order shown).

For unicast sidelink communications in FR2, the UE 115-a and the UE 115-b may perform implicit/explicit beam maintenance by measuring CSI-RS and reporting L1-RSRP/SINR. The UE 115-a and the UE 115-b may also perform CSI reporting by transmitting/receiving CSI-RS via multi-port CSI-RS resources and reporting RI/CQI. However, when the UE 115-a and the UE 115-b are both mobile devices, beams may change relatively fast, and the UEs 115 may be unable to accurately track beam changes using separate beam management and CSI reporting procedures. Thus, it may be desirable to merge beam management and CSI reporting operations to reduce the delay associated with tracking dynamic beam variations between the UE 115-a and the UE 115-b.

The techniques described herein may enable the UE 115-a and the UE 115-b (i.e., sidelink devices in FR2) to perform a joint beam management and CSI reporting procedure using multi-port CSI-RS resources instead of single-port CSI-RS resources for transmit/receive beam sweeping operations. For example, the UE 115-a may measure various multi-port CSI-RS resources, select a transmit/receive beam based on the measurements, and report RI/CQI (instead of L1-RSRP/SINR) for the selected transmit/receive beam. The UE 115-a and the UE 115-b may perform the joint beam management and CSI reporting procedure in accordance with various measurement parameters and reporting parameters, some of which are shown below in Table 1.

TABLE 1
Joint Beam Management and CSI Reporting
Configuration Parameters

| | | Joint Beam Management |
|---|---|---|
| | Beam Management | and CSI Reporting |
| | Procedure | Procedure |
| CSI-RS Resource | 1-port CSI-RS | Multi-port CSI-RS |
| Type | Resource | Resource |
| Transmit Beam | 1-port Beam Sweep | Multi-port Beam Sweep |
| Configuration | | |
| Receive Beam | Fixed 2-port Receive | Fixed 2-port Receive |
| Configuration | Beam | Beam |
| Reporting Metric(s) | L1-RSRP/SINR | RI/CQI |
| Quantity of reported | K | K |
| CSI-RS resource(s) | | |
| Beam Indication | Selected CRI | Selected CRI |
| Type | | |

FIG. 6A illustrates an example of an explicit beam maintenance procedure between the UE 115-a and the UE 115-b. At 605, the UE 115-b may transmit CSI-RS via 1-port CSI-RS resources in accordance with a 1-port transmit beam sweeping pattern. In some examples, the UE 115-b may provide the UE 115-a with a PC5-RRC configuration for the 1-port CSI-RS resources and the 1-port transmit beam sweeping pattern.

At 610, the UE 115-a may receive the CSI-RS via the 1-port CSI-RS resources using a fixed 2-port receive beam configuration, where the UE 115-b may transmit on multiple CSI-RS resources with transmission beam sweeping. The UE 115-a may determine an L1-RSRP/SINR for the 1-port CSI-RS resources based on measurements of the CSI-RS. For example, the UE 115-a may measure L1-RSRP/SINR on multiple CSI-RS resources using a fixed receive beam.

At 615, the UE 115-a may report the L1-RSRP/SINR for the top K CSI-RS resources, where K is specified in the joint beam management and CSI reporting scheme parameters shown in Table 1. In some examples, the UE 115-a may report the L1-RSRP/SINR via a sidelink CSI reporting MAC-CE.

At 620, the UE 115-b may select a transmit beam to use for subsequent communications with the UE 115-a based on the L1-RSRP/SINR provided by the UE 115-a. In some examples, the transmit beam selected by the UE 115-b may correspond to one of the CSI-RS resources identified by the UE 115-a.

At 625, the UE 115-b may transmit an indication of the selected transmit beam to the UE 115-a. In some examples, the indication may include a CRI corresponding to the selected transmit beam of the UE 115-b. In other examples, the indication may be or include a TCI associated with the selected transmit beam.

FIG. 6B illustrates an example of a joint beam management and CSI reporting procedure between the UE 115-a and the UE 115-b. As described herein, the UE 115-a may receive an indication of a joint beam management and CSI reporting scheme from the UE 115-b or another device (such as the network entity 105-a described with reference to FIG. 2). The joint beam management and CSI reporting scheme may include one or more measurement parameters and reporting parameters, some of which are listed in Table 1. At 630, the UE 115-b may transmit CSI-RS via multi-port CSI-RS resources in accordance with a multi-port transmit beam sweeping configuration.

At 635, the UE 115-a may receive the CSI-RS via the multi-port CSI-RS resources using a fixed multi-port receive beam configuration in accordance with the measurement parameters of the joint beam management and CSI reporting scheme. The UE 115-a may calculate or otherwise determine an RI/CQI for the multi-port CSI-RS resources based on measurements of the CSI-RS.

At 640, the UE 115-a may report RI/CQI for the top K CSI-RS resources, where K is specified in the joint beam management and CSI reporting parameters shown in Table 1. In some examples, K (the number of reported CSI-RS resources) may be negotiated (i.e., jointly determined) by the UE 115-a and the UE 115-b. The UE 115-a may indicate RI/CQI values for the top K CSI-RS resources using cri-RI-CQI report signaling mechanisms for Uu CSI reporting (reportQuanty=cri-RI-CQI). When K is 1, the UE 115-a may use 3 reserved bits in the sidelink CSI reporting MAC-CE to indicate CRI(s) for up to 8 CSI-RS resources. For more than 8 CSI-RS resources, the MAC-CE format may be extended to accommodate more bits for additional CRI(s). When K is greater than 1, the UE 115-a may use a modified sidelink MAC-CE format with enough bits to support reporting RI/CQI for multiple cri-RI-CQIs.

In some implementations (e.g., when K=1), the UE 115-a may select the top CSI-RS resource (for example, the CSI-RS resource with the most favorable CQI) and report a corresponding cri-RI-CQI to the UE 115-b. Accordingly, the UE 115-b may transmit HARQ-ACK feedback for the sidelink CSI reporting MAC-CE from the UE 115-a, and may perform a transmit beam update X milliseconds after transmission of the HARQ-ACK feedback. Similarly, the UE 115-a may perform a receive beam update X milliseconds after receiving the HARQ-ACK feedback from the UE 115-b.

In other implementations (e.g., when K>1), the UE 115-a may select the top K CSI-RS resources and report corresponding cri-RI-CQI(s) to the UE 115-b. Accordingly, the UE 115-b may determine or otherwise select a transmit beam to use for subsequent communications with the UE 115-a, and may transmit an indication of a TCI associated with the selected transmit beam. In turn, the UE 115-a may transmit HARQ-ACK feedback for the TCI from the UE 115-b, and may perform a receive beam update X milliseconds after transmission of the HARQ-ACK feedback. Likewise, the UE 115-b may perform a transmit beam update X milliseconds after receiving the HARQ-ACK feedback from the UE 115-a, where X is specified in a PC5-RRC configuration.

At 645, the UE 115-b may select a transmit beam to use for subsequent communications with the UE 115-a based on the RI/CQI provided by the UE 115-a. In some examples, the transmit beam selected by the UE 115-b may correspond to the top CSI-RS resource identified by the UE 115-a.

At 650, the UE 115-b may transmit an indication of the selected transmit beam to the UE 115-a. In some examples, the indication may include a CRI corresponding to the selected transmit beam. In other examples, the indication may be or include a TCI associated with the selected transmit beam.

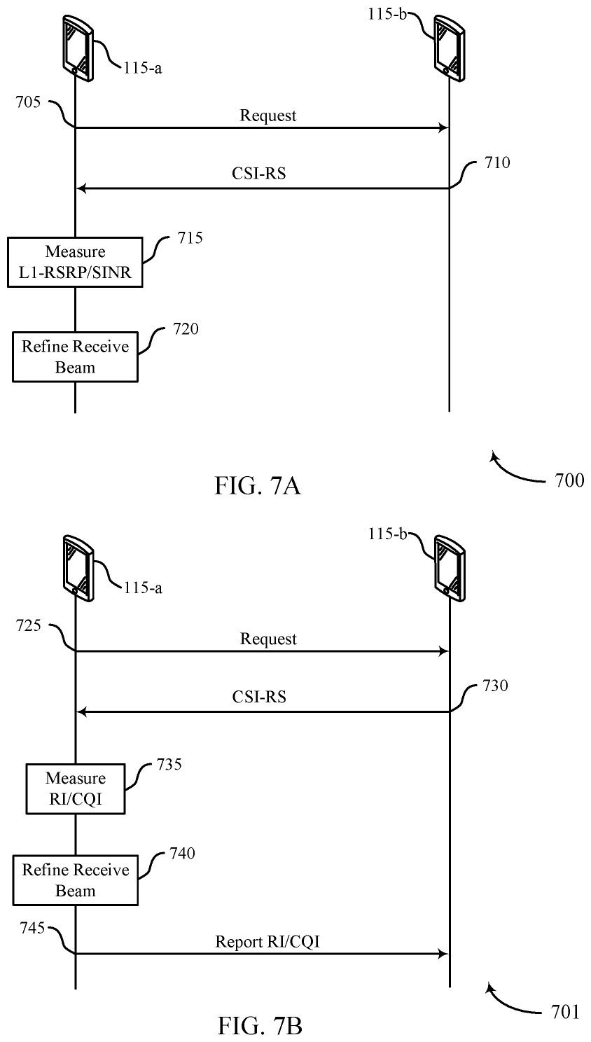

FIGS. 7A and 7B illustrate examples of a process flow 700 and a process flow 701 that support joint beam management and CSI reporting for sidelink communications in accordance with one or more aspects of the present disclosure. The process flow 700 and the process flow 701 may implement or be implemented by aspects of any of the wireless communications systems, resource diagrams, beam management procedures, or process flows described with reference to FIGS. 1 through 6. For example, the process flow 700 and the process flow 701 include a UE 115-a (e.g., a first device) and a UE 115-b (e.g., a second device), which may be examples of corresponding devices described herein, including with reference to FIGS. 1 through 6. In the following description of the process flow 700 and the process flow 701, operations between the UE 115-a and the UE 115-b may be added, omitted, or performed in a different order (with respect to the exemplary order shown).

For unicast sidelink communications in FR2, the UE 115-a and the UE 115-b may perform implicit/explicit beam maintenance by measuring CSI-RS and reporting L1-RSRP/SINR. The UE 115-a and the UE 115-b may also perform CSI reporting by transmitting/receiving CSI-RS via multi-port CSI-RS resources and reporting RI/CQI. However, when the UE 115-a and the UE 115-b are both mobile devices, beams may change relatively fast, and the UEs 115 may be unable to accurately track beam changes using separate beam management and CSI reporting procedures. Thus, it may be desirable to merge beam management and CSI reporting operations to reduce the delay associated with tracking dynamic beam variations between the UE 115-a and the UE 115-b.

The techniques described herein may enable the UE 115-a and the UE 115-b (i.e., sidelink devices in FR2) to perform a joint beam management and CSI reporting procedure using multi-port CSI-RS resources instead of single-port CSI-RS resources for transmit/receive beam sweeping and repetition. For example, the UE 115-a may measure various multi-port CSI-RS resources, select a transmit/receive beam based on the measurements, and report RI/CQI (instead of L1-RSRP/SINR) for the selected transmit/receive beam. The UE 115-a and the UE 115-b may perform the joint beam management and CSI reporting procedure in accordance with various measurement parameters and reporting parameters, some of which are shown below in Table 2.

TABLE 2
Joint Beam Management and CSI Reporting
Configuration Parameters

| | | Joint Beam Management |
|---|---|---|
| | Beam Management | and CSI Reporting |
| | Procedure | Procedure |
| CSI-RS Resource | 1-port CSI-RS | Multi-port CSI-RS |
| Type | Resource | Resource |
| Transmit Beam | 1-port Fixed Beam | Multi-port Fixed Beam |
| Configuration | with Repetition | with Repetition |
| Receive Beam | 2-port Receive Beam | 2-port Receive Beam |
| Configuration | Sweep | Sweep |
| Reporting Metric(s) | N/A | RI/CQI |
| Quantity of reported | N/A | 1 |
| CSI-RS resource(s) | | |

FIG. 7A illustrates an example of an implicit beam maintenance procedure between the UE 115-a and the UE 115-b. At 705, the UE 115-a (e.g., a first device) may transmit a request for the UE 115-b (e.g., a second device) to transmit CSI-RS in accordance with a transmit beam repetition pattern, such as a 1-port fixed beam repetition pattern. In some examples, the UE 115-b may provide the UE 115-a with a PC5-RRC configuration that indicates the 1-port fixed beam repetition pattern.

At 710, the UE 115-b may transmit CSI-RS via 1-port CSI-RS resources using the 1-port fixed beam repetition pattern in accordance with the request from the UE 115-a. The UE 115-a may receive the CSI-RS using a 2-port receive beam sweeping pattern indicated by the PC5-RRC configuration.

At 715, the UE 115-a may calculate or otherwise determine an L1-RSRP/SINR for the 1-port CSI-RS resources based on receiving and measuring the CSI-RS in accordance with the 2-port receive beam sweeping configuration.

At 720, the UE 115-a may perform a receive beam refinement procedure based on the L1-RSRP/SINR of the 1-port CSI-RS resources. In accordance with the implicit beam management procedure, the UE 115-a may perform the beam refinement without signaling or otherwise indicating the L1-RSRP/SINR to the UE 115-b.

FIG. 7B illustrates an example of a joint beam management and CSI reporting procedure between the UE 115-a and the UE 115-b. As described herein, the UE 115-a may receive an indication of a joint beam management and CSI reporting scheme from the UE 115-b or another device (such as the network entity 105-a described with reference to FIG. 2). The joint beam management and CSI reporting scheme may include one or more measurement parameters and reporting parameters, some of which are listed in Table 2. At 725, the UE 115-a may transmit a request for the UE 115-b to transmit CSI-RS in accordance with a multi-port fixed beam repetition pattern.

At 730, the UE 115-b may transmit CSI-RS via multi-port CSI-RS resources using the multi-port fixed beam repetition pattern in accordance with the request from the UE 115-a. The UE 115-a may receive the CSI-RS via the multi-port CSI-RS resources using a multi-port receive beam sweeping pattern in accordance with the measurement parameters of the joint beam management and CSI reporting scheme.

At 735, the UE 115-a may calculate or otherwise determine an RI/CQI for the multi-port CSI-RS resources based on receiving and measuring the CSI-RS in accordance with multi-port receive beam sweeping pattern.

At 740, the UE 115-a may perform a beam refinement procedure to refine or otherwise update a receive beam of the UE 115-a based on the RI/CQI associated with the multi-port CSI-RS resources.

At 745, the UE 115-a may report an RI/CQI associated with the refined receive beam of the UE 115-a in accordance with the reporting parameters of the joint beam management and CSI reporting scheme. In some examples, the UE 115-a may indicate the RI/CQI via a sidelink CSI reporting MAC-CE. CRI reporting for implicit beam maintenance may not be needed, as the UE 115-a transmits all of the CSI-RS(s) using the same transmit beam. In some examples, the UE 115-b may perform a beam update immediately after measuring RI/CQI (rather than waiting X milliseconds after transmitting/receiving HARQ-ACK feedback). The receive/transmit beam update performed by the UE 115-a may be transparent to the UE 115-b.

The transmit/receive beam of the UE 115-b can be updated/refined in a similar manner. Once complete, the UE 115-a may exchange sidelink communications with the UE 115-b in FR2 using the refined transmit/receive beams.

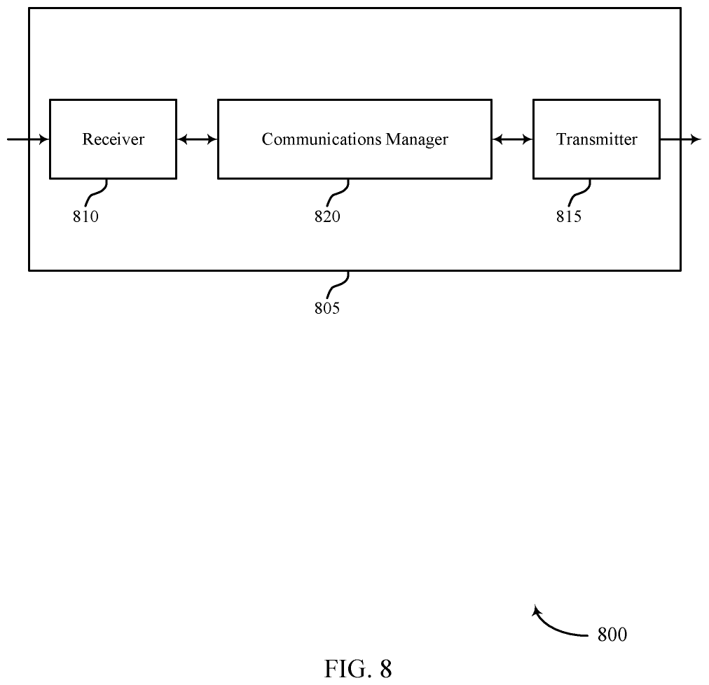

FIG. 8 shows a block diagram 800 of a device 805 that supports joint beam management and CSI reporting for sidelink communications in accordance with one or more aspects of the present disclosure. The device 805 may be an example of aspects of a communication device, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to joint beam management and CSI reporting for sidelink communications). Information may be passed on to other components of the device 805. The receiver 810 may utilize a single antenna or multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to joint beam management and CSI reporting for sidelink communications). In some examples, the transmitter 815 may be co-located with a receiver 810 in a transceiver module. The transmitter 815 may utilize a single antenna or multiple antennas.

The communications manager 820, the receiver 810, the transmitter 815, or various combinations thereof or various components thereof may be examples of means for performing various aspects of joint beam management and CSI reporting for sidelink communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first device (such as the device 805) in accordance with examples disclosed herein. For example, the communications manager 820 is capable of, configured to, or operable to support a means for transmitting or receiving an indication of a joint beam management and CSI reporting scheme that identifies one or more measurement parameters and one or more reporting parameters. The communications manager 820 is capable of, configured to, or operable to support a means for receiving multiple reference signals via a set of multi-port CSI-RS resources in accordance with the one or more measurement parameters of the joint beam management and CSI reporting scheme. The communications manager 820 is capable of, configured to, or operable to support a means for transmitting, in accordance with the one or more reporting parameters of the joint beam management and CSI reporting scheme, a message that indicates a first set of reporting metrics associated with a first multi-port CSI-RS resource of the set of multi-port CSI-RS resources.

Additionally, or alternatively, the communications manager 820 may support wireless communication at a second device (such as the device 805) in accordance with examples disclosed herein. For example, the communications manager 820 is capable of, configured to, or operable to support a means for transmitting or receiving an indication of a joint beam management and CSI reporting scheme that identifies one or more measurement parameters and one or more reporting parameters. The communications manager 820 is capable of, configured to, or operable to support a means for transmitting multiple reference signals via a set of multi-port CSI-RS resources in accordance with the one or more measurement parameters of the joint beam management and CSI reporting scheme. The communications manager 820 is capable of, configured to, or operable to support a means for receiving, in accordance with the one or more reporting parameters of the joint beam management and CSI reporting scheme, a message that indicates a first set of reporting metrics associated with a first multi-port CSI-RS resource of the set of multi-port CSI-RS resources.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources, among other examples.

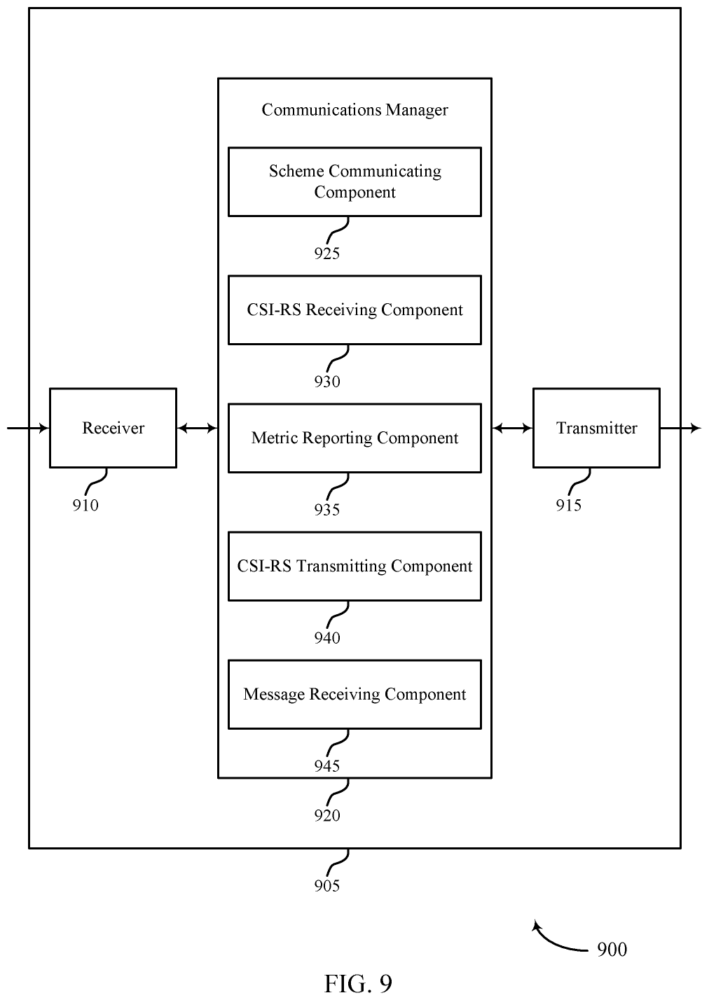

FIG. 9 shows a block diagram 900 of a device 905 that supports joint beam management and CSI reporting for sidelink communications in accordance with one or more aspects of the present disclosure. The device 905 may be an example of aspects of a device 805 or a UE 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to joint beam management and CSI reporting for sidelink communications). Information may be passed on to other components of the device 905. The receiver 910 may utilize a single antenna or multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to joint beam management and CSI reporting for sidelink communications). In some examples, the transmitter 915 may be co-located with a receiver 910 in a transceiver module. The transmitter 915 may utilize a single antenna or multiple antennas.

The device 905, or various components thereof, may be an example of means for performing various aspects of joint beam management and CSI reporting for sidelink communications as described herein. For example, the communications manager 920 may include a scheme communicating component 925, a CSI-RS receiving component 930, a metric reporting component 935, a CSI-RS transmitting component 940, a message receiving component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first device (such as the device 905) in accordance with examples disclosed herein. The scheme communicating component 925 is capable of, configured to, or operable to support a means for transmitting or receiving an indication of a joint beam management and CSI reporting scheme that identifies one or more measurement parameters and one or more reporting parameters. The CSI-RS receiving component 930 is capable of, configured to, or operable to support a means for receiving multiple reference signals via a set of multi-port CSI-RS resources in accordance with the one or more measurement parameters of the joint beam management and CSI reporting scheme. The metric reporting component 935 is capable of, configured to, or operable to support a means for transmitting, in accordance with the one or more reporting parameters of the joint beam management and CSI reporting scheme, a message that indicates a first set of reporting metrics associated with a first multi-port CSI-RS resource of the set of multi-port CSI-RS resources.

Additionally, or alternatively, the communications manager 920 may support wireless communication at a second device (such as the device 905) in accordance with examples disclosed herein. The scheme communicating component 925 is capable of, configured to, or operable to support a means for transmitting or receiving an indication of a joint beam management and CSI reporting scheme that identifies one or more measurement parameters and one or more reporting parameters. The CSI-RS transmitting component 940 is capable of, configured to, or operable to support a means for transmitting multiple reference signals via a set of multi-port CSI-RS resources in accordance with the one or more measurement parameters of the joint beam management and CSI reporting scheme. The message receiving component 945 is capable of, configured to, or operable to support a means for receiving, in accordance with the one or more reporting parameters of the joint beam management and CSI reporting scheme, a message that indicates a first set of reporting metrics associated with a first multi-port CSI-RS resource of the set of multi-port CSI-RS resources.

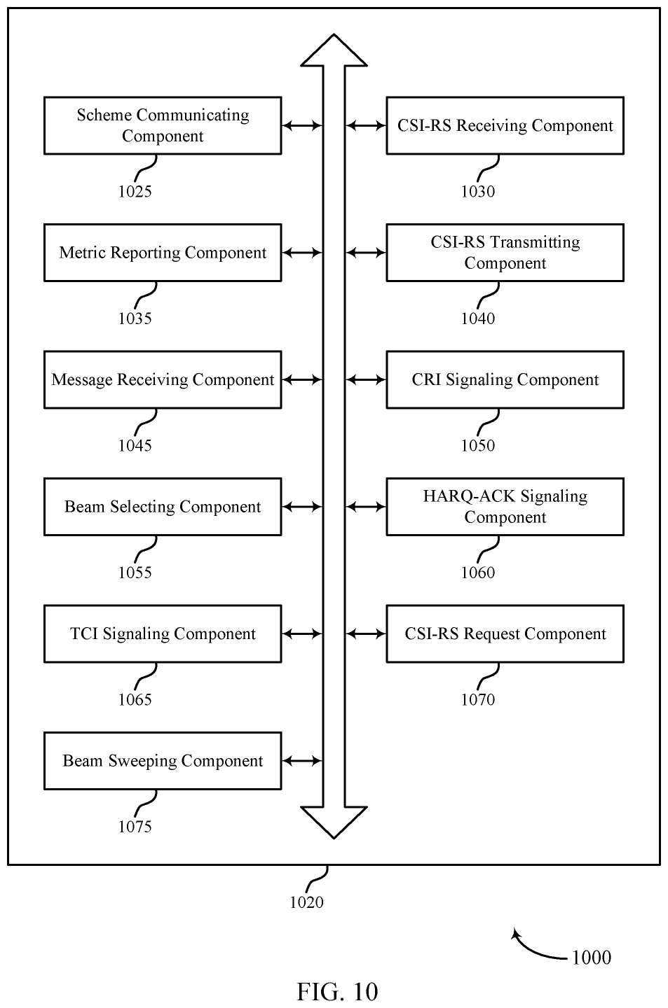

FIG. 10 shows a block diagram 1000 of a communications manager 1020 that supports joint beam management and CSI reporting for sidelink communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of joint beam management and CSI reporting for sidelink communications as described herein. For example, the communications manager 1020 may include a scheme communicating component 1025, a CSI-RS receiving component 1030, a metric reporting component 1035, a CSI-RS transmitting component 1040, a message receiving component 1045, a CRI signaling component 1050, a beam selecting component 1055, an HARQ-ACK signaling component 1060, a TCI signaling component 1065, a CSI-RS request component 1070, a beam sweeping component 1075, or any combination thereof. Each of these components may communicate, directly or indirectly, with one another (e.g., via one or more buses).

The communications manager 1020 may support wireless communication at a first device in accordance with examples disclosed herein. The scheme communicating component 1025 is capable of, configured to, or operable to support a means for transmitting or receiving an indication of a joint beam management and CSI reporting scheme that identifies one or more measurement parameters and one or more reporting parameters. The CSI-RS receiving component 1030 is capable of, configured to, or operable to support a means for receiving multiple reference signals via a set of multi-port CSI-RS resources in accordance with the one or more measurement parameters of the joint beam management and CSI reporting scheme. The metric reporting component 1035 is capable of, configured to, or operable to support a means for transmitting, in accordance with the one or more reporting parameters of the joint beam management and CSI reporting scheme, a message that indicates a first set of reporting metrics associated with a first multi-port CSI-RS resource of the set of multi-port CSI-RS resources.

In some examples, the first set of reporting metrics include an RI and a CQI associated with the first multi-port CSI-RS resource. In some examples, the message further indicates a second multiple reporting metrics associated with a second multi-port CSI-RS resource of the multiple multi-port CSI-RS resources.

In some examples, the one or more reporting parameters indicate a quantity of multi-port CSI-RS resources for which the first device is to provide reporting metrics. In some examples, the first device includes a sidelink UE operating in FR2.

In some examples, the CRI signaling component 1050 is capable of, configured to, or operable to support a means for receiving an indication of a CRI associated with a transmit beam of a second device from which the multiple reference signals are received. In some examples, the CRI signaling component 1050 is capable of, configured to, or operable to support a means for where the transmit beam of the second device corresponds to the first multi-port CSI-RS resource.

In some examples, the multiple reference signals are received using a fixed multi-port receive beam of the first device. In some examples, the beam selecting component 1055 is capable of, configured to, or operable to support a means for selecting a transmit or receive beam to use for communications with a second device based on measuring the multiple reference signals in accordance with the one or more measurement parameters of the joint beam management and CSI reporting scheme.

In some examples, the first multi-port CSI-RS resource corresponds to the transmit or receive beam selected by the first device. In some examples, the message includes a sidelink CSI reporting MAC-CE indicating the first set of reporting metrics associated with the first multi-port CSI-RS resource.

In some examples, a format of the sidelink CSI reporting MAC-CE is based on a quantity of multi-port CSI-RS resources for which the first device is to provide reporting metrics. In some examples, the message includes a quantity of bits that indicate a CRI associated with the first multi-port CSI-RS resource.

In some examples, the HARQ-ACK signaling component 1060 is capable of, configured to, or operable to support a means for receiving HARQ-ACK feedback for the message indicating the first set of reporting metrics associated with the first multi-port CSI-RS resource. In some examples, the beam selecting component 1055 is capable of, configured to, or operable to support a means for updating a receive beam of the first device after a threshold quantity of milliseconds has elapsed with respect to reception of the HARQ-ACK feedback.

In some examples, the joint beam management and CSI reporting scheme indicates the threshold quantity of milliseconds. In some examples, the receive beam of the first device corresponds to the first multi-port CSI-RS resource.

In some examples, the TCI signaling component 1065 is capable of, configured to, or operable to support a means for receiving a second message including a TCI associated with a transmit beam of a second device from which the multiple reference signals are received. In some examples, the HARQ-ACK signaling component 1060 is capable of, configured to, or operable to support a means for transmitting HARQ-ACK feedback for the second message in accordance with the joint beam management and CSI reporting scheme.

In some examples, the message further indicates a second multiple reporting metrics associated with a second multi-port CSI-RS resource of the multiple multi-port CSI-RS resources. In some examples, the TCI associated with the transmit beam of the second device corresponds to the first multi-port CSI-RS resource or the second multi-port CSI-RS resource.

In some examples, the beam selecting component 1055 is capable of, configured to, or operable to support a means for updating a receive beam of the first device based on the TCI associated with the transmit beam of the second device. In some examples, the beam selecting component 1055 is capable of, configured to, or operable to support a means for where the receive beam is updated after a threshold quantity of milliseconds has elapsed with respect to transmission of the HARQ-ACK feedback.

In some examples, the multiple reference signals are received in accordance with a multi-port receive beam sweeping scheme. In some examples, the CSI-RS request component 1070 is capable of, configured to, or operable to support a means for transmitting a request for a second device to transmit reference signals in accordance with a beam repetition pattern, where the multiple reference signals are received in accordance with the request.

In some examples, the beam sweeping component 1075 is capable of, configured to, or operable to support a means for performing a multi-port receive beam sweeping procedure based on receiving the multiple reference signals in accordance with the one or more measurement parameters of the joint beam management and CSI reporting scheme.

In some examples, the beam selecting component 1055 is capable of, configured to, or operable to support a means for updating a receive beam of the first device based on a result of the multi-port receive beam sweeping procedure. In some examples, the first multi-port CSI-RS resource corresponds to the receive beam updated by the first device.

Additionally, or alternatively, the communications manager 1020 may support wireless communication at a second device in accordance with examples disclosed herein. In some examples, the scheme communicating component 1025 is capable of, configured to, or operable to support a means for transmitting or receiving an indication of a joint beam management and CSI reporting scheme that identifies one or more measurement parameters and one or more reporting parameters. The CSI-RS transmitting component 1040 is capable of, configured to, or operable to support a means for transmitting multiple reference signals via a set of multi-port CSI-RS resources in accordance with the one or more measurement parameters of the joint beam management and CSI reporting scheme. The message receiving component 1045 is capable of, configured to, or operable to support a means for receiving, in accordance with the one or more reporting parameters of the joint beam management and CSI reporting scheme, a message that indicates a first set of reporting metrics associated with a first multi-port CSI-RS resource of the set of multi-port CSI-RS resources.

In some examples, the multiple reference signals are transmitted using multiple transmit beams of the second device in accordance with a multi-port beam sweeping pattern. In some examples, the multiple reference signals are transmitted using a first transmit beam of the second device in accordance with a multi-port fixed beam repetition pattern. In some examples, the first set of reporting metrics include an RI and a CQI associated with the first multi-port CSI-RS resource.

In some examples, the message further indicates a second multiple reporting metrics associated with a second multi-port CSI-RS resource of the multiple multi-port CSI-RS resources. In some examples, the second device includes a sidelink UE operating in FR2.

In some examples, the CRI signaling component 1050 is capable of, configured to, or operable to support a means for transmitting an indication of a CRI associated with a transmit beam of the second device. In some examples, the CRI signaling component 1050 is capable of, configured to, or operable to support a means for where the transmit beam of the second device corresponds to the first multi-port CSI-RS resource.

In some examples, the beam selecting component 1055 is capable of, configured to, or operable to support a means for selecting a transmit or receive beam to use for communications with a first device based on the first set of reporting metrics associated with the first multi-port CSI-RS resource.

In some examples, the message includes a sidelink CSI reporting MAC-CE indicating the first set of reporting metrics associated with the first multi-port CSI-RS resource. In some examples, the message further indicates a CRI associated with the first multi-port CSI-RS resource.

In some examples, the HARQ-ACK signaling component 1060 is capable of, configured to, or operable to support a means for transmitting HARQ-ACK feedback for the message indicating the first set of reporting metrics associated with the first multi-port CSI-RS resource. In some examples, the beam selecting component 1055 is capable of, configured to, or operable to support a means for updating a transmit beam of the second device after a threshold quantity of milliseconds has elapsed with respect to transmission of the HARQ-ACK feedback.

In some examples, the joint beam management and CSI reporting scheme indicates the threshold quantity of milliseconds. In some examples, the transmit beam of the second device corresponds to the first multi-port CSI-RS resource.

In some examples, the TCI signaling component 1065 is capable of, configured to, or operable to support a means for transmitting a second message including a TCI associated with a transmit beam of the second device. In some examples, the HARQ-ACK signaling component 1060 is capable of, configured to, or operable to support a means for receiving HARQ-ACK feedback for the second message in accordance with the joint beam management and CSI reporting scheme.

In some examples, the beam selecting component 1055 is capable of, configured to, or operable to support a means for updating a transmit beam of the second device after a threshold quantity of milliseconds has elapsed with respect to reception of the HARQ-ACK feedback.

In some examples, the message further indicates a second multiple reporting metrics associated with a second multi-port CSI-RS resource of the multiple multi-port CSI-RS resources. In some examples, the TCI from the second message corresponds to the first multi-port CSI-RS resource or the second multi-port CSI-RS resource.

In some examples, the CSI-RS request component 1070 is capable of, configured to, or operable to support a means for receiving a request for the second device to transmit reference signals in accordance with a beam repetition pattern, where the multiple reference signals are transmitted in accordance with the request.

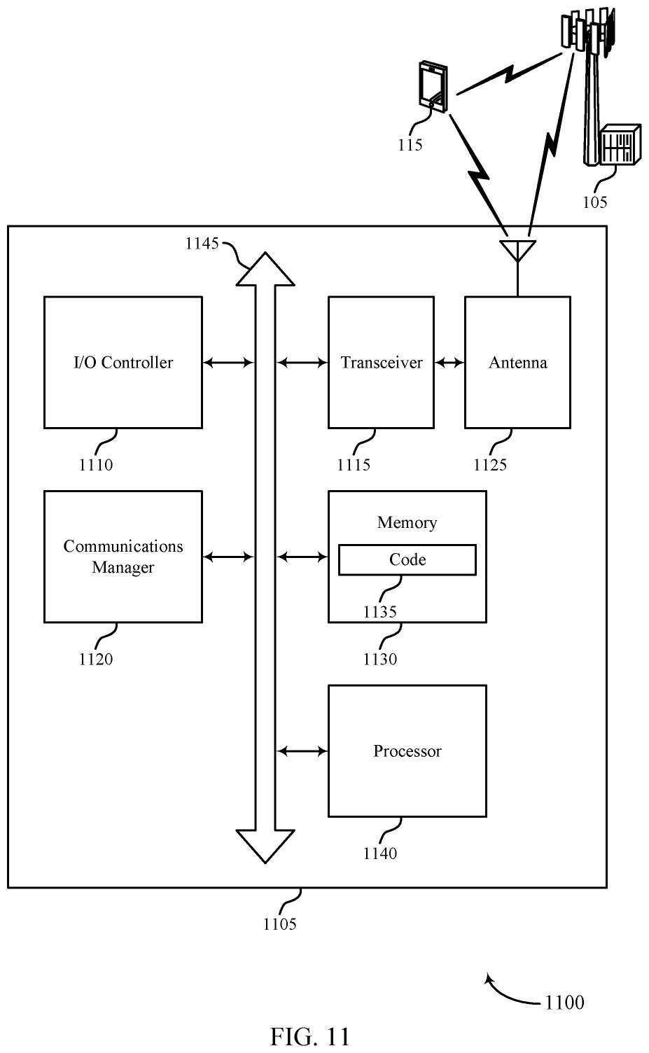

FIG. 11 shows a diagram of a system 1100 including a device 1105 that supports joint beam management and CSI reporting for sidelink communications in accordance with one or more aspects of the present disclosure. The device 1105 may be an example of or include the components of a device 805, a device 905, or a communication device, as described herein. The device 1105 may include components for bi-directional voice and data communications including components for transmitting and receiving communications, such as a communications manager 1120, an I/O controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting joint beam management and CSI reporting for sidelink communications). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a first device (such as the device 1105) in accordance with examples disclosed herein. For example, the communications manager 1120 is capable of, configured to, or operable to support a means for transmitting or receiving an indication of a joint beam management and CSI reporting scheme that identifies one or more measurement parameters and one or more reporting parameters. The communications manager 1120 is capable of, configured to, or operable to support a means for receiving multiple reference signals via a set of multi-port CSI-RS resources in accordance with the one or more measurement parameters of the joint beam management and CSI reporting scheme. The communications manager 1120 is capable of, configured to, or operable to support a means for transmitting, in accordance with the one or more reporting parameters of the joint beam management and CSI reporting scheme, a message that indicates a first set of reporting metrics associated with a first multi-port CSI-RS resource of the set of multi-port CSI-RS resources.

Additionally, or alternatively, the communications manager 1120 may support wireless communication at a second device (such as the device 1105) in accordance with examples disclosed herein. For example, the communications manager 1120 is capable of, configured to, or operable to support a means for transmitting or receiving an indication of a joint beam management and CSI reporting scheme that identifies one or more measurement parameters and one or more reporting parameters. The communications manager 1120 is capable of, configured to, or operable to support a means for transmitting multiple reference signals via a set of multi-port CSI-RS resources in accordance with the one or more measurement parameters of the joint beam management and CSI reporting scheme. The communications manager 1120 is capable of, configured to, or operable to support a means for receiving, in accordance with the one or more reporting parameters of the joint beam management and CSI reporting scheme, a message that indicates a first set of reporting metrics associated with a first multi-port CSI-RS resource of the set of multi-port CSI-RS resources.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability, among other examples.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of joint beam management and CSI reporting for sidelink communications as described herein, or the processor 1140 and the memory 1130 may be otherwise configured to perform or support such operations.

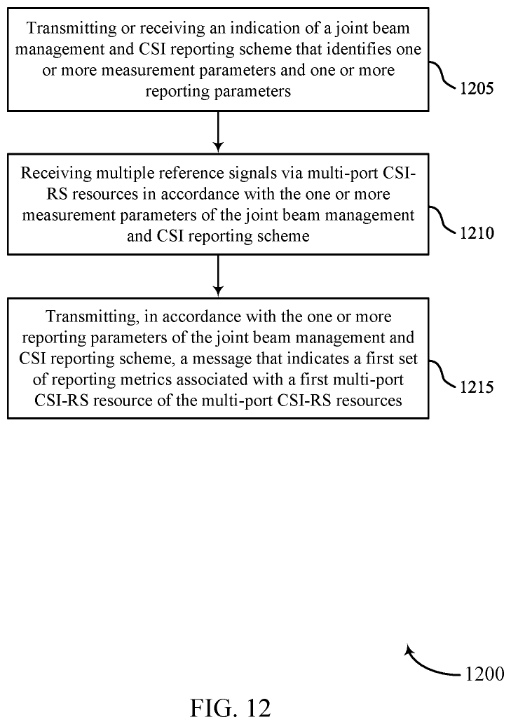

FIG. 12 shows a flowchart illustrating a method 1200 that supports joint beam management and CSI reporting for sidelink communications in accordance with aspects of the present disclosure. The operations of the method 1200 may be implemented by a communication device or components thereof. For example, the operations of the method 1200 may be performed by a UE 115, as described with reference to FIGS. 1 through 11. In some examples, the communication device may execute a set of instructions to control the functional elements of the communication device to perform the described functions. Additionally, or alternatively, the communication device may perform aspects of the described functions using special-purpose hardware.

At 1205, the method may include transmitting or receiving an indication of a joint beam management and CSI reporting scheme that identifies one or more measurement parameters and one or more reporting parameters. The operations of 1205 may be performed in accordance with examples disclosed herein. In some examples, aspects of the operations of 1205 may be performed by a scheme communicating component 1025, as described with reference to FIG. 10.

At 1210, the method may include receiving multiple reference signals via multi-port CSI-RS resources in accordance with the one or more measurement parameters of the joint beam management and CSI reporting scheme. The operations of 1210 may be performed in accordance with examples disclosed herein. In some examples, aspects of the operations of 1210 may be performed by a CSI-RS receiving component 1030, as described with reference to FIG. 10.

At 1215, the method may include transmitting, in accordance with the one or more reporting parameters of the joint beam management and CSI reporting scheme, a message that indicates a first set of reporting metrics associated with a first multi-port CSI-RS resource of the multi-port CSI-RS resources. The operations of 1215 may be performed in accordance with examples disclosed herein. In some examples, aspects of the operations of 1215 may be performed by a metric reporting component 1035, as described with reference to FIG. 10.

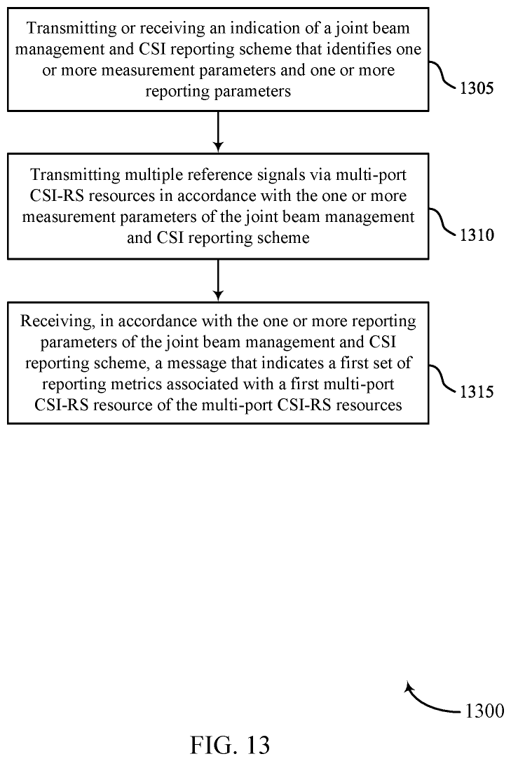

FIG. 13 shows a flowchart illustrating a method 1300 that supports joint beam management and CSI reporting for sidelink communications in accordance with aspects of the present disclosure. The operations of the method 1300 may be implemented by a communication device or components thereof. For example, the operations of the method 1300 may be performed by a UE 115, as described with reference to FIGS. 1 through 11. In some examples, the communication device may execute a set of instructions to control the functional elements of the communication device to perform the described functions. Additionally, or alternatively, the communication device may perform aspects of the described functions using special-purpose hardware.

At 1305, the method may include transmitting or receiving an indication of a joint beam management and CSI reporting scheme that identifies one or more measurement parameters and one or more reporting parameters. The operations of 1305 may be performed in accordance with examples disclosed herein. In some examples, aspects of the operations of 1305 may be performed by a scheme communicating component 1025, as described with reference to FIG. 10.

At 1310, the method may include transmitting multiple reference signals via multi-port CSI-RS resources in accordance with the one or more measurement parameters of the joint beam management and CSI reporting scheme. The operations of 1310 may be performed in accordance with examples disclosed herein. In some examples, aspects of the operations of 1310 may be performed by a CSI-RS transmitting component 1040, as described with reference to FIG. 10.

At 1315, the method may include receiving, in accordance with the one or more reporting parameters of the joint beam management and CSI reporting scheme, a message that indicates a first set of reporting metrics associated with a first multi-port CSI-RS resource of the multi-port CSI-RS resources. The operations of 1315 may be performed in accordance with examples disclosed herein. In some examples, aspects of the operations of 1315 may be performed by a message receiving component 1045, as described with reference to FIG. 10.

The following provides an overview of aspects of the present disclosure:

Aspect 1: A method for wireless communication at a first device, comprising: transmitting or receiving an indication of a joint beam management and CSI reporting scheme that identifies one or more measurement parameters and one or more reporting parameters; receiving a plurality of reference signals via a plurality of multi-port CSI-RS resources in accordance with the one or more measurement parameters of the joint beam management and CSI reporting scheme; and transmitting, in accordance with the one or more reporting parameters of the joint beam management and CSI reporting scheme, a message that indicates a first plurality of reporting metrics associated with a first multi-port CSI-RS resource of the plurality of multi-port CSI-RS resources.

Aspect 2: The method of aspect 1, wherein the first plurality of reporting metrics comprise an RI and a CQI associated with the first multi-port CSI-RS resource.

Aspect 3: The method of any of aspects 1 through 2, wherein the message further indicates a second plurality of reporting metrics associated with a second multi-port CSI-RS resource of the plurality of multi-port CSI-RS resources.

Aspect 4: The method of any of aspects 1 through 3, wherein the one or more reporting parameters indicate a quantity of multi-port CSI-RS resources for which the first device is to provide reporting metrics.

Aspect 5: The method of any of aspects 1 through 4, wherein the first device comprises a sidelink UE operating in FR2.

Aspect 6: The method of any of aspects 1 through 5, further comprising: receiving an indication of a CRI associated with a transmit beam of a second device from which the plurality of reference signals are received, wherein the transmit beam of the second device corresponds to the first multi-port CSI-RS resource.

Aspect 7: The method of any of aspects 1 through 6, wherein the plurality of reference signals are received using a fixed multi-port receive beam of the first device.

Aspect 8: The method of any of aspects 1 through 7, further comprising: selecting a transmit or receive beam to use for communications with a second device based at least in part on measuring the plurality of reference signals in accordance with the one or more measurement parameters of the joint beam management and CSI reporting scheme.

Aspect 9: The method of aspect 8, wherein the first multi-port CSI-RS resource corresponds to the transmit or receive beam selected by the first device.

Aspect 10: The method of any of aspects 1 through 9, wherein the message comprises a sidelink CSI reporting MAC-CE indicating the first plurality of reporting metrics associated with the first multi-port CSI-RS resource.

Aspect 11: The method of aspect 10, wherein a format of the sidelink CSI reporting MAC-CE is based at least in part on a quantity of multi-port CSI-RS resources for which the first device is to provide reporting metrics.

Aspect 12: The method of any of aspects 1 through 11, wherein the message comprises a quantity of bits that indicate a CRI associated with the first multi-port CSI-RS resource.

Aspect 13: The method of any of aspects 1 through 12, further comprising: receiving HARQ-ACK feedback for the message indicating the first plurality of reporting metrics associated with the first multi-port CSI-RS resource; and updating a receive beam of the first device after a threshold quantity of milliseconds has elapsed with respect to reception of the HARQ-ACK feedback.

Aspect 14: The method of aspect 13, wherein the joint beam management and CSI reporting scheme indicates the threshold quantity of milliseconds.

Aspect 15: The method of any of aspects 13 through 14, wherein the receive beam of the first device corresponds to the first multi-port CSI-RS resource.

Aspect 16: The method of any of aspects 1 through 15, further comprising: receiving a second message comprising a TCI associated with a transmit beam of a second device from which the plurality of reference signals are received; and transmitting HARQ-ACK feedback for the second message in accordance with the joint beam management and CSI reporting scheme.

Aspect 17: The method of aspect 16, wherein the message further indicates a second plurality of reporting metrics associated with a second multi-port CSI-RS resource of the plurality of multi-port CSI-RS resources; and the TCI associated with the transmit beam of the second device corresponds to the first multi-port CSI-RS resource or the second multi-port CSI-RS resource.

Aspect 18: The method of any of aspects 16 through 17, further comprising: updating a receive beam of the first device based at least in part on the TCI associated with the transmit beam of the second device, wherein the receive beam is updated after a threshold quantity of milliseconds has elapsed with respect to transmission of the HARQ-ACK feedback.

Aspect 19: The method of any of aspects 1 through 18, wherein the plurality of reference signals are received in accordance with a multi-port receive beam sweeping scheme.

Aspect 20: The method of any of aspects 1 through 19, further comprising: transmitting a request for a second device to transmit reference signals in accordance with a beam repetition pattern, wherein the plurality of reference signals are received in accordance with the request.

Aspect 21: The method of any of aspects 1 through 20, further comprising: performing a multi-port receive beam sweeping procedure based at least in part on receiving the plurality of reference signals in accordance with the one or more measurement parameters of the joint beam management and CSI reporting scheme; and updating a receive beam of the first device based at least in part on a result of the multi-port receive beam sweeping procedure.

Aspect 22: The method of aspect 21, wherein the first multi-port CSI-RS resource corresponds to the receive beam updated by the first device.

Aspect 23: A method for wireless communication at a second device, comprising: transmitting or receiving an indication of a joint beam management and CSI reporting scheme that identifies one or more measurement parameters and one or more reporting parameters; transmitting a plurality of reference signals via a plurality of multi-port CSI-RS resources in accordance with the one or more measurement parameters of the joint beam management and CSI reporting scheme; and receiving, in accordance with the one or more reporting parameters of the joint beam management and CSI reporting scheme, a message that indicates a first plurality of reporting metrics associated with a first multi-port CSI-RS resource of the plurality of multi-port CSI-RS resources.

Aspect 24: The method of aspect 23, wherein the plurality of reference signals are transmitted using a plurality of transmit beams of the second device in accordance with a multi-port beam sweeping pattern.

Aspect 25: The method of any of aspects 23 through 24, wherein the plurality of reference signals are transmitted using a first transmit beam of the second device in accordance with a multi-port fixed beam repetition pattern.

Aspect 26: The method of any of aspects 23 through 25, wherein the first plurality of reporting metrics comprise an RI and a CQI associated with the first multi-port CSI-RS resource.

Aspect 27: The method of any of aspects 23 through 26, wherein the message further indicates a second plurality of reporting metrics associated with a second multi-port CSI-RS resource of the plurality of multi-port CSI-RS resources.

Aspect 28: The method of any of aspects 23 through 27, wherein the second device comprises a sidelink UE operating in FR2.

Aspect 29: The method of any of aspects 23 through 28, further comprising: transmitting an indication of a CRI associated with a transmit beam of the second device, wherein the transmit beam of the second device corresponds to the first multi-port CSI-RS resource.

Aspect 30: The method of any of aspects 23 through 29, further comprising: selecting a transmit or receive beam to use for communications with a first device based at least in part on the first plurality of reporting metrics associated with the first multi-port CSI-RS resource.

Aspect 31: The method of any of aspects 23 through 30, wherein the message comprises a sidelink CSI reporting MAC-CE indicating the first plurality of reporting metrics associated with the first multi-port CSI-RS resource.

Aspect 32: The method of any of aspects 23 through 31, wherein the message further indicates a CRI associated with the first multi-port CSI-RS resource.

Aspect 33: The method of any of aspects 23 through 32, further comprising: transmitting HARQ-ACK feedback for the message indicating the first plurality of reporting metrics associated with the first multi-port CSI-RS resource; and updating a transmit beam of the second device after a threshold quantity of milliseconds has elapsed with respect to transmission of the HARQ-ACK feedback.

Aspect 34: The method of aspect 33, wherein the joint beam management and CSI reporting scheme indicates the threshold quantity of milliseconds.

Aspect 35: The method of any of aspects 33 through 34, wherein the transmit beam of the second device corresponds to the first multi-port CSI-RS resource.

Aspect 36: The method of any of aspects 23 through 35, further comprising: transmitting a second message comprising a TCI associated with a transmit beam of the second device; and receiving HARQ-ACK feedback for the second message in accordance with the joint beam management and CSI reporting scheme.

Aspect 37: The method of aspect 36, further comprising: updating a transmit beam of the second device after a threshold quantity of milliseconds has elapsed with respect to reception of the HARQ-ACK feedback.

Aspect 38: The method of any of aspects 36 through 37, wherein the message further indicates a second plurality of reporting metrics associated with a second multi-port CSI-RS resource of the plurality of multi-port CSI-RS resources; and the TCI from the second message corresponds to the first multi-port CSI-RS resource or the second multi-port CSI-RS resource.

Aspect 39: The method of any of aspects 23 through 38, further comprising: receiving a request for the second device to transmit reference signals in accordance with a beam repetition pattern, wherein the plurality of reference signals are transmitted in accordance with the request.

Aspect 40: An apparatus for wireless communication at a first device, comprising a processor, memory coupled with the processor, and instructions stored in the memory and executable by the processor to cause the apparatus to perform a method of any of aspects 1 through 22.

Aspect 41: An apparatus for wireless communication at a first device, comprising at least one means for performing a method of any of aspects 1 through 22.

Aspect 42: A non-transitory computer-readable medium storing code for wireless communication at a first device, the code comprising instructions executable by a processor to perform a method of any of aspects 1 through 22.

Aspect 43: An apparatus for wireless communication at a second device, comprising a processor, memory coupled with the processor, and instructions stored in the memory and executable by the processor to cause the apparatus to perform a method of any of aspects 23 through 39.

Aspect 44: An apparatus for wireless communication at a second device, comprising at least one means for performing a method of any of aspects 23 through 39.

Aspect 45: A non-transitory computer-readable medium storing code for wireless communication at a second device, the code comprising instructions executable by a processor to perform a method of any of aspects 23 through 39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first device, comprising:
one or more processors;
one or more memories coupled with the one or more processors; and
instructions stored in the one or more memories and executable by the one or more processors to cause the apparatus to:
transmit or receive an indication of a joint beam management and channel state information (CSI) reporting scheme that identifies one or more measurement parameters and one or more reporting parameters;
receive a plurality of reference signals via a plurality of multi-port CSI reference signal (CSI-RS) resources in accordance with the one or more measurement parameters of the joint beam management and CSI reporting scheme; and
transmit, in accordance with the one or more reporting parameters of the joint beam management and CSI reporting scheme, a message that indicates a first plurality of reporting metrics associated with a first multi-port CSI-RS resource of the plurality of multi-port CSI-RS resources.

2. The apparatus of claim 1, wherein the first plurality of reporting metrics comprise a rank indicator (RI) and a channel quality indicator (CQI) associated with the first multi-port CSI-RS resource.

3. The apparatus of claim 1, wherein the message further indicates a second plurality of reporting metrics associated with a second multi-port CSI-RS resource of the plurality of multi-port CSI-RS resources.

4. The apparatus of claim 1, wherein the one or more reporting parameters indicate a quantity of multi-port CSI-RS resources for which the first device is to provide reporting metrics.

5. The apparatus of claim 1, wherein the first device comprises a sidelink user equipment (UE) operating in Frequency Range 2 (FR2).

6. The apparatus of claim 1, wherein the instructions are further executable by the one or more processors to cause the apparatus to:
receive an indication of a CSI-RS resource identifier (CRI) associated with a transmit beam of a second device from which the plurality of reference signals are received,
wherein the transmit beam of the second device correspond to the first multi-port CSI-RS resource.

7. The apparatus of claim 1, wherein the plurality of reference signals are received using a fixed multi-port receive beam of the first device.

8. The apparatus of claim 1, wherein the instructions are further executable by the one or more processors to cause the apparatus to:
select a transmit or receive beam to use for communications with a second device based at least in part on measurement of the plurality of reference signals in accordance with the one or more measurement parameters of the joint beam management and CSI reporting scheme.

9. The apparatus of claim 1, wherein the message comprises a sidelink CSI reporting medium access control-control element (MAC-CE) indicating the first plurality of reporting metrics associated with the first multi-port CSI-RS resource.

10. The apparatus of claim 1, wherein the message comprises a quantity of bits that indicate a CSI-RS resource identifier (CRI) associated with the first multi-port CSI-RS resource.

11. The apparatus of claim 1, wherein the instructions are further executable by the one or more processors to cause the apparatus to:
receive hybrid automatic repeat request acknowledgement (HARQ-ACK) feedback for the message indicating the first plurality of reporting metrics associated with the first multi-port CSI-RS resource; and
update a receive beam of the first device after a threshold quantity of milliseconds has elapsed with respect to reception of the HARQ-ACK feedback.

12. The apparatus of claim 1, wherein the instructions are further executable by the one or more processors to cause the apparatus to:
receive a second message comprising a transmission configuration indicator (TCI) associated with a transmit beam of a second device from which the plurality of reference signals are received; and
transmit hybrid automatic repeat request acknowledgement (HARQ-ACK) feedback for the second message in accordance with the joint beam management and CSI reporting scheme.

13. The apparatus of claim 12, wherein the instructions are further executable by the one or more processors to cause the apparatus to:
update a receive beam of the first device based at least in part on the TCI associated with the transmit beam of the second device,
wherein the receive beam is updated after a threshold quantity of milliseconds has elapsed with respect to transmission of the HARQ-ACK feedback.

14. The apparatus of claim 1, wherein the plurality of reference signals are received in accordance with a multi-port receive beam sweeping scheme.

15. The apparatus of claim 1, wherein the instructions are further executable by the one or more processors to cause the apparatus to:
transmit a request for a second device to transmit reference signals in accordance with a beam repetition pattern,
wherein the plurality of reference signals are received in accordance with the request.

16. The apparatus of claim 1, wherein the instructions are further executable by the one or more processors to cause the apparatus to:
perform a multi-port receive beam sweeping procedure based at least in part on reception of the plurality of reference signals in accordance with the one or more measurement parameters of the joint beam management and CSI reporting scheme; and
update a receive beam of the first device based at least in part on a result of the multi-port receive beam sweeping procedure.

17. An apparatus for wireless communication at a second device, comprising:
one or more processors;
one or more memories coupled with the one or more processors; and
instructions stored in the one or more memories and executable by the one or more processors to cause the apparatus to:
transmit or receive an indication of a joint beam management and channel state information (CSI) reporting scheme that identifies one or more measurement parameters and one or more reporting parameters;
transmit a plurality of reference signals via a plurality of multi-port CSI reference signal (CSI-RS) resources in accordance with the one or more measurement parameters of the joint beam management and CSI reporting scheme; and
receive, in accordance with the one or more reporting parameters of the joint beam management and CSI reporting scheme, a message that indicates a first plurality of reporting metrics associated with a first multi-port CSI-RS resource of the plurality of multi-port CSI-RS resources.

18. The apparatus of claim 17, wherein the plurality of reference signals are transmitted using a plurality of transmit beams of the second device in accordance with a multi-port beam sweeping pattern.

19. The apparatus of claim 17, wherein the plurality of reference signals are transmitted using a first transmit beam of the second device in accordance with a multi-port fixed beam repetition pattern.

20. A method for wireless communication at a first device, comprising:
transmitting or receiving an indication of a joint beam management and channel state information (CSI) reporting scheme that identifies one or more measurement parameters and one or more reporting parameters;
receiving a plurality of reference signals via a plurality of multi-port CSI reference signal (CSI-RS) resources in accordance with the one or more measurement parameters of the joint beam management and CSI reporting scheme; and
transmitting, in accordance with the one or more reporting parameters of the joint beam management and CSI reporting scheme, a message that indicates a first plurality of reporting metrics associated with a first multi-port CSI-RS resource of the plurality of multi-port CSI-RS resources.
